(19) United States
(12) Patent Application Publication
(10) Pub. No.: US 2012/0224062 A1
(43) Pub. Date: Sep. 6, 2012

(54) HEAD UP DISPLAYS

(75) Inventors: Lilian Lacoste, Cambridgeshire (GB); Dominik Stindt, Cambridgeshire (GB); Edward Buckley, Cambridgeshire (GB)

(73) Assignee: LIGHT BLUE OPTICS LTD, Cambridgeshire (GB)

(21) Appl. No.: 13/389,436

(22) PCT Filed: Jul. 22, 2010
(86) PCT No.: PCT/GB2010/051209

§ 371 Date: May 16, 2012

(30) Foreign Application Priority Data
Aug. 7, 2009 (GB) 0913799.3
Aug. 13, 2009 (GB) 0914174.8

(51) Int. Cl. H04N 7/18; G09G 5/00

(52) U.S. Cl. 348/148; 345/633; 348/E07.085

(57) ABSTRACT

We describe a road vehicle contact-analogue head up display (HUD) comprising: a laser-based virtual image generation system to provide a 2D virtual image; exit pupil expander optics to enlarge an eye box of the HUD; a system for sensing a lateral road position relative to the road vehicle and a vehicle pitch or horizon position; a symbol image generation system to generate symbology for the HUD; and an imagery processor coupled to the symbol image generation system, to the sensor system and to said virtual image generation system, to receive and process symbology image data to convert this to data defining a 2D image for display dependent on the sensed road position such that when viewed the virtual image appears to be at a substantially fixed position relative to said road; and wherein the virtual image is at a distance of at least 5 m from said viewer.

### FIELD OF THE INVENTION

This invention relates to improved Head Up Displays (HUDs), more particularly to so-called contact analogue HUDs, and to light shields for HUDs, for inhibiting both reflections from incoming light such as sunlight and damaging injection of light into the projection optics.

### BACKGROUND TO THE INVENTION

Automotive head-up displays (HUDs) are used to extend the display of data from the instrument cluster to the windshield area by presenting a virtual image to the driver. An example is shown in FIG. 1, in which lens power provided by the concave and fold mirrors of the HUD optics form a virtual image displayed at an apparent depth of around 2.5 m. Such virtual images are typically presented an at apparent distance of between 2 m and 2.5 m from the viewer's eyes, thereby reducing the need to re-accommodate focus when transitioning between displayed driving information and the outside world. This method of presenting data also reduces the amount of visual scanning necessary to view the instrumentation symbology, and potentially enables the display of imagery which is conformal with the outside world, as provided by contact analogue HUDs. General background material on head-up displays can be found in: E. Maiser, 2006, “Automobile & Avionics Displays”, adria (Advanced Displays Research Integration Action) display network Europe, 4^{th} adria roadmapping workshop, 22 Feb. 2006.

The phrase contact analogue HUD has its origins in displays and particularly HUDs for aircraft pilots, where “contact” flight is flight using external visual cues (the horizon, clouds, the earth and the like), as distinct from instrument flight, and broadly speaking a contact analogue HUD provides visually analogous information which simulates contact flight (see, for example, U.S. Pat. No. 5,072,218). In an automotive environment a contact analogue HUD spatially relates the displayed data to the outside world so that the real world view is blended with computer generated graphics so that the graphics are perceived as integrated with the real world environment (an augmented reality system). Because the driver's view of the real world environment changes with the driver's head position and gaze, hitherto such devices have required complex eye tracking technology to adapt the content to the driver's position. Conventional optics make other approaches difficult. In the prior art there are mainly two system concepts which address the problem of providing a contact analogue HUD display: a tilted image source approach, and a stereoscopic image source approach.

The tilted image source approach uses a tilted image source (meaning non normal to the optical axis) in an optical configuration in which addressing different areas on the display in the vertical dimension changes the distance of the virtual image. In this way by displaying an appropriate image the HUD displays a virtual image which appears to be lying of the ground. Such an approach is described in: Bubb, H. (1978): Einrichtung zur optischen Anzeige eines veranderlichen Sicherheitsabstandes eines Fahrzeuges, Schutzrecht DE 2633067 C2 (1978-02-02); WO2009/071139; and Bubb, 2009, Head-Up-Display in Motor Cars Technology and Application, Technische Universität Munich. This approach induces constraints on the optics by requiring a high quality image within a range of different magnifications.

The stereoscopic image source approach generates different, stereoscopic images for the left and right eyes, resulting in binocular disparity leading to a sensation of depth of the perceived image. Such an approach is described in Nakamura, K., Inada, J., Kakizaki, M., Fujikawa, T., Kasiwada, S, Ando, H., Kawahara, N.: Windshield Display for Intelligent Transport System. Proceedings of the 11th World Congress on Intelligent Transportation Systems. Nagoya, Japan 2004. However this approach is known to cause visual fatigue and requires a head/eye tracking system which adds significantly to the overall complexity of the HUD.

Further background work has been carried out at the Technical University of Munich. Examples of contact analogue symbology can be found in: Schneid, 2009, Entwicklung and Erprobung eines kontaktanalogen Head-up-Displays im Fahrzeug, PhD Thesis, TU Munich. A study by the Institute of Ergonomics at the University (Bergmeier, 2008, augmented reality in vehicle—technical realisation of a contact analogue head-up display under automotive capable aspects; usefulness exemplified through night vision systems, F2008-02-043) compared a “suggested icon distance” with perceived icon distance for a range of suggested distances. An example of an automotive contact analogue HUD using augmented reality software is described in: “Contact-analog Information Representation in an Automotive Head-Up Display” T. Poitschke, M. Ablassmeier, and G. Rigoll, Institute for Human-Machine Communication Technische Universität München, S. Bardins, S. Kohlbecher, and E. Schneider, Centre for Sensorimotor Research Ludwig-Maximilians-University Munich; ETRA 2008, Savannah, Ga., Mar. 26-28, 2008; this system also uses eyetracking. Other background material can be found in: WO2007/036397 (US2009/0195414), which describes a contact analogue-type display for a road vehicle but without any implementation details; EP0330184A, which describes a contact analogue HUD for an aircraft; US2005/0154505; and US2007/0233380.

There therefore exists a continuing need for improved approaches to the implementation of an automotive contact analogue head-up display (HUD).

In addition, two common problems observed in existing systems are sun-related damage to the HUD, and sunlight reflections from inside the system. Sunlight-related damage is typically caused by sunlight entering the optical system and ending up concentrated at the location of an image generation device such as a spatial light modulator (SLM). The concentration of the spot of light depends upon the level of collimation of the system and can be high enough to permanently damage the imaging system.

The problem of sunlight reflections from an HUD occurs especially in HUD systems employing mirrors—the sunlight can then be reflected out of the HUD by one of the mirrors of the optical combination and cause light pollution or worse inside the cockpit, for example causing flares on the windshield (windscreen) of a road vehicle such as a car. However, the problem of reflected sunlight is not exclusive to systems using mirrors as just a few percent reflection of sunlight from a glass surface without an anti-reflection coating can be sufficient to “blind” a driver. We will describe techniques which address both these problems and which, in so doing, help to reduce the integration constraints on a HUD by reducing the effects of solar exposure.

A range of solutions already exists to mitigate solar exposure problems, applied depending on the use case. To reduce sun-related damage by restricting sunlight entering the system and potentially damaging the imager, existing solutions include:
1. Preventing the sun entering the system by a system of shutters.
2. Filtering the light inside the system (HUD light can be monochromatic and polarized) to minimize the actual part of the spectrum hitting the imager.
3. De-collimate the HUD to increase the spot size of the sunlight at the imager's level (reducing the pick exposure).
4. Using a heat drain layer at the display level to avoid hot spots cause by solar exposure.
5. Introducing a combiner with optical power (non flat) to cause the sun entering directly the system (i.e. without reflecting on the combiner) to be significantly non-collimated.

The solutions implemented in an HUD with solar exposure problems are normally a combination of these. For example, Fujitsu has a number of patents in the HUD field including a patent relating to the use of a folding shutter for an HUD. Nissan, in JP61238015A describe an arrangement including a transparent plate with plural light shield plates arranged in a transparent resin film which transmit only light which is incident within a narrow range of angles to the perpendicular to the film surface; a polarising plate is also employed to cut off polarised external light (the windshield is at the Brewster angle so that light transmitted through this is relatively polarised). Many examples of background prior art can also be found in Head Up Display patents held by Nippon Seiki Co Limited. Further examples of background prior art can be found in: JP7261674, JP9185011, JP2004/196020 and JP2006/011168, JP61238015A and GB2123974A.

An apparently similar approach to that described in JP'015 was employed in a Jaguar fighter HUD from Smiths Aerospace, using a black honeycomb structure on top of the projection optics in a plane separate from an image plane of the HUD. This arrangement prevented sunlight at a shallow angle, for example at sunrise, from entering the HUD. Smiths have a substantial number of patents to Head Up Displays, to which reference may also be made.

The problem of avoiding light pollution resulting from light reflected out of an HUD system is mainly a problem for mirror-based HUD systems, including automotive HUD systems. In such systems, because the freedom of movement of the vehicle is reduced there is a limited range of different possible sun positions and the orientation of the HUD in the dashboard can be selected to minimise problems from sunlight reflection from the HUD. In general it is not necessary to block all sunlight reflections, merely those which cause particular problems by, for example, reflecting sunlight onto the windshield—some reflected sunlight on, for example, the internal roof of the car may be tolerated. Nonetheless this approach puts significant constraints on the integration of an HUD into a dashboard (where space is generally very limited). Moreover the design of the HUD must typically incorporate significant light-absorbing surfaces to attenuate sunlight reflected by internal mirrors, for example the last mirror of the projector. As HUDs are becoming increasingly common in cars the constraints imposed by these solutions are becoming an important obstacle to the implementation of a low-cost, high-performance HUD product policy by manufacturers.

The inventors have previously described new techniques for expanding the exit pupil of a head up display, in particular in GB0902468.8, “Optical Systems”, filed on 16 Feb. 2009, and PCT/GB2010/050251 (incorporated by reference). These techniques employ a parallel sided waveguide into which light is injected at an angle and which multiply the exit pupil of an HUD by providing a plurality of output beams, tiling the exit pupils, the output beams emerging substantially parallel to one another and tilted with respect to a normal to the parallel sided waveguide. The inventors have recognised that such an exit pupil expander enables new techniques to be employed for inhibiting reflected sunlight and reducing sun-related damage and that, moreover, these new techniques are not limited to an exit pupil expander of the type previously described, although they are particularly useful when employed with such an exit pupil or eye box expander.

### SUMMARY OF THE INVENTION

According to a first aspect of the invention there is therefore provided a road vehicle contact-analogue head up display (HUD), the head up display comprising: a laser-based virtual image generation system, the virtual image generation system comprising at least one laser light source coupled to image generating optics to provide a light beam bearing one or more substantially two-dimensional virtual images; exit pupil expander optics optically coupled to said laser-based virtual image generation system to receive said light beam bearing said one or more substantially two-dimensional virtual images and to enlarge an eye box of said HUD for viewing said virtual images; a sensor system input to receive sensed road position data defining a road position relative to said road vehicle, said road position data including data defining a lateral position of a road on which the vehicle is travelling relative to said road vehicle, and a vehicle pitch or horizon position; a symbol image generation system to generate symbology image data for contact-analogue display by said HUD; and an imagery processor coupled to said symbol image generation system, to said sensor system input and to said virtual image generation system, to receive said symbology image data for contact-analogue display and to process said symbology image data to convert said symbology image data to data defining a substantially two dimensional image dependent on said sensed road position data for input to said virtual image generation system for display by said HUD such that when said one or more substantially two dimensional images are viewed with said HUD the viewed virtual image appears to a viewer at a substantially fixed position relative to said road; and wherein said virtual image is at a distance of at least 5 m from said viewer.

The use of a laser-based virtual image generator system provides particular advantages albeit it also has special problems associated with the small etendue of laser sources. Broadly speaking etendue can be approximated by the product of the area of a source and the solid angle subtended by light from the source (as seen from an entrance pupil); more particularly it is an area integral over the surface and solid angle. For a head-up display broadly speaking the etendue is a product of the area of the eyebox and the solid angle of the field of view. The etendue is preserved in a geometrical optical system and hence if a laser is employed to generate the light from which the image is produced absent other strategies the etendue of the system will be small (the light from the laser originates from a small area and has a small initial divergence by contrast, say, with the etendue of a light emitting diode which is large because the emission from and LED is approximately Lambertian).

To address this we employ exit pupil expander optics to increase the etendue of the head-up display (HUD), to increase the size of the region over which the displayed imagery may be viewed.

The inventors have recognised that a further advantage of this approach, in broad terms, the eyebox size of the HUD is decorrelated from the image source etendue, which in turn enables a relatively small optical package size because small optical elements can be employed for image magnification. This optical architecture in its turn facilitates a practical physical size for a system in which the virtual image is moved well beyond 2 m-2.5 m, to at least 5 m, more preferably at least 6 m, 10 m, 30 m, 50 m, or where the virtual image is substantially at infinity. This is advantageous because in a system where a substantially 2D virtual image is displayed in a virtual image plane at such a from the driver, the depth of the perceived distance of portions of the symbology can manipulated. Because the virtual image is a long way away from the viewer the binocular cues are effectively removed, and this enables monocular cues to then be applied to control the perceived distance of portions of the symbology—there is no need to fight against binocular cues. For this reason, also, preferred embodiments of the system employ monocular cues to change the perceived distance of the virtual image, more particularly to bring portions of the symbology graphics of the displayed virtual image towards the driver/viewer although the actual distance of the virtual image plane from the driver/viewer (sometimes called the collimation distance) remains fixed.

In preferred embodiments of the contact analogue HUD the exit pupil expander optics are configured to provide a (horizontal or vertical) field of view for the virtual image of at least 5 degrees, more preferably at least 8 degrees or 10 degrees. The above described optical architecture facilitates achieving this wide field of view, which is important in achieving a convincing degree of realism for the driver that the display graphics are truly “attached to” the road. In embodiments of the head-up display the widest field of view is the vertical field of view, to facilitate applying monocular cues to display content over a range of different apparent distances for the driver. In preferred embodiments which possess such an enhanced field of view, preferably a laser-based virtual image generation system is employed which has a resolution, in the replay field of the virtual image (i.e. as perceived by the driver) of at least 640×480 pixels, in embodiments the resolution being greater in the vertical than in the horizontal direction.

As previously mentioned, preferred embodiments of the head-up display apply monocular cues to change the perceived symbology distance. The “familiar size” of a virtual object is potentially particularly useful because firstly it provides absolute rather than relative distance information to a viewer, and secondly because it can bring the perceived distance of an object closer than the distance of the virtual image. Thus in embodiments the symbology image data includes data for a graphical representation of a real-life object, such as a road sign, and a monocular cue is applied by scaling the size of the graphical representation of the object such that when the graphical representation is viewed the scaled size matches the expected real size for the object at the desired apparent depth. This is achieved by storing object size data for the symbol, this data defining a size of the real-life object, and then data defining a desired apparent depth for the object can be used to scale the size of the symbol (knowing the magnification of the HUD) so that, when displayed, the scaled size is correct for the desired apparent distance, given the magnification of the HUD.

Another group of monocular cues which may advantageously be employed in embodiments of the system are cues which link the displayed symbology to sensed external environmental conditions. As well as imparting a further degree of realism to the displayed symbology, cues of this type can be particularly effective. Thus, in embodiments, the orientation of the vehicle is sensed and a combination of the time of day (and approximate, estimate or measured latitude) and the vehicle orientation is used to determine a direction of the sun relative to the vehicle, and this in turn is used to add one or more shadows to a displayed symbol or graphical object. The size and shape of a shadow provides information about the depth and shape of the object casting the shadow, and the further a shadow moves from the object casting it, the further the object is perceived to be from the background. In embodiments one or more graphical elements or symbols of the displayed symbology may also be modified, dependent on a determined level of driver visibility (due to fog, rain and the like) and/or based on external illumination conditions (for example day/night) to modify the apparent visual depth of one symbol/graphical element relative to another. Thus it will be appreciated that the application of a monocular cue is field-dependent, that is the cue is applied selectively within the field of graphical elements/symbols to change the apparent depth of one element/symbol with reference to another.

In embodiments a head tracker can be employed to determine the driver's viewpoint and to apply artificial parallax to a monocular cue, to move one portion of the symbology with respect to another portion of the symbology to give the impression of parallax.

In embodiments the location of the car with reference to the road comprises a lateral position of the car with reference to the road, for example determined from a forward-facing camera coupled to an image processor configured to identify edges and/or the centre and/or lane boundaries of the road. Preferably the horizon position is also identified, for example either directly from a captured image or by extrapolating edges/boundaries of the road towards a vanishing point. The horizon may be used to determine the vehicle pitch or the vehicle pitch may be determined directly, for example from a pitch sensor. Vehicle pitch is especially important as the pitch of the vehicle and driver changes significantly on braking and acceleration and the displayed symbology should be moved to compensate for this to maintain the contact analogue illusion, that is to maintain the symbology at a substantially fixed position relative to the road. Some preferred embodiments of the system determine three attitude angles of the vehicle (pitch, roll and yaw).

In embodiments of the display the symbology image data comprises model data, more particularly three-dimensional model data defining a three-dimensional model of the symbology to be presented to the driver. The sensed road position data including vehicle pitch/horizon position is then used to determine an effective viewpoint of the car/driver into the 3D model of the symbology which is mapped to the real-world road. This facilitates handling of symbology from disparate sources, for example a combination of one or more of topographic data of a similar type to that employed with in-car GPS (global positioning system) navigational aids, a marker at an apparent distance substantially equal to a stopping distance of the vehicle, road signs, a pedestrian marker (to highlight a pedestrian in front of the vehicle), hazard warnings and the like.

The skilled person will appreciate that the functions of the symbol image generation system and of the imagery processor may be combined in a single physical device.

Preferred embodiments of the contact analogue HUD incorporate an occlusion detection system comprising, for example, an occlusion detection processor coupled to an occlusion detection signal input to detect an occlusion, in particular, another vehicle in front. In embodiments the occlusion detection signal may comprise a one-, two- or three-dimensional radar or visual image (here visual includes infrared/ultraviolet), and the occlusion detection processor is configured to identify a shape in front of the vehicle which would occlude the displayed symbology were the symbology to exist as real-world graphics—that is if a real-world object in front of the vehicle would occlude the symbology/graphical elements were they present in the real world then to depict this occlusion and hence preserve the illusion of a real-world (augmented reality) display. In embodiments this is facilitated by employing a three-dimensional model of the symbology, since the occlusion can be included in this model environment and then the scene rendered using the car viewpoint data to generate an appropriate two-dimensional image for display. In simpler embodiments, however, when an occlusion is detected the system may revert to a simpler mode in which the contact analogue mapping of symbology to the road is dispensed with to provide a “flat” two-dimensional view.

In preferred embodiments of the head up display (HUD) the exit pupil expander optics comprise pair of planar, parallel reflecting surfaces defining a waveguide, and the laser-based virtual image generation system is configured to launch a collimated beam bearing the one or more substantially 2D images into a region between the parallel surfaces. In a preferred implementation of this approach light then escapes from the waveguide at each reflection of the beam from one of the surfaces (a front surface).

In other embodiments, however, the beam may be collimated after the exit pupil expander. Likewise, in other embodiments the exit pupil expander optics may alternatively comprise a microlens array or diffractive beam splitter, or a diffuser, preferably a phase-only scattering diffuser. (Incorporating a diffuser can effectively partially lose the geometric properties of the optical system by projecting and re-imaging the image, although the etendue will still tend to be low and use of a diffuser only can result in a bulky optical arrangement).

In more detail, in some preferred embodiments the front optical surface is a partially transmitting mirrored surface, to transmit a proportion of the collimated beam when reflecting the beam such that at each reflection at the front optical surface a replica of the image is output from these optics. The rear optical surface is a coated, mirrored surface. The front optical surface may either transmit a first polarisation and reflect an orthogonal polarisation, or transmit a proportion of the incident light substantially irrespective of polarisation. In the first case a phase retarding layer is included between the reflecting optical surfaces such for each reflection from the rear surface (two passes through the phase retarding layer) a component of light at the first polarisation is introduced, which is transmitted through the front optical surface. In the second case the transmission of the partially transmitting mirror depends on the number of replicas desired—for example for four replicas, the mirror transmission is typically between 10% and 50%, but for ten or more replicas the range is typically in the range 0.1% to 10%. Typically the beam is launched into at an angle in the range 15°-45° to the normal to the parallel, planar reflecting surfaces. Increased optical efficiency can be achieved by stacking two (or more) sets of image replication optics one above another so that a replicated beam from a first set of image replication optics provides an input beam to a second set of image replication optics (the latter preferably with a smaller spacing between the planar reflectors). This can be used to replicate beams in one dimension or in two dimensions.

The skilled person will appreciate that a contact analogue HUD as described above will generally employ a combiner, which may comprise a coating on the windshield (windscreen). The use of a laser facilitates use of a chromatically selective coating to combine the HUD display with the view through the windshield. Alternatively a separate, substantially planar combiner may be provided.

In preferred embodiments a laser light source is coupled to a spatial light modulator (SLM), preferably a microdisplay for compactness, via SLM illumination optics. However in other embodiments a scanned laser-based virtual image generation system may be employed, for example deflecting the laser beam in two-dimensions to create a raster scanned image.

In some embodiments the laser-based virtual image generation system is a holographic image generation system, and a hologram generation processor drives the SLM with hologram data for the desired image. Thus in embodiments the processor converts input image data to target image data prior to converting this to a hologram, for a colour image compensating for the different scaling of the colour components of the multicolour projected image for replication when calculating this target image. Single or multiple chromatically selective coatings may be provided on the combiner for a colour display. Where a combiner with a curved surface, such as a windshield, is employed the processor may be configured to apply a wavefront and/or geometry correction when generating the hologram data, responsive to stored wavefront correction data for the surface, to correct the image for aberration due to the shape of the surface. This is described in more detail in our earlier patent application WO2008/120015, hereby incorporated by reference (in particular the portion under the heading “Aberration correction”).

In embodiments the processor is coupled to memory storing processor control code to implement an OSPR (One Step Phase Retrieval)—type procedure. Thus in embodiments an image is displayed by displaying a plurality of temporal holographic subframes on the SLM such that the corresponding projected images (each of which has the spatial extent of the output beam) average in a viewer's eye to give the impression of a reduced noise version of the image for display. (It will be appreciated that for these purposes, video may be viewed as a succession of images for display, a plurality of temporal holographic subframes being provided for each image of the succession of images). We have previously described such techniques in, for example: WO 2005/059660 (Noise Suppression Using One Step Phase Retrieval), WO 2006/134398 (Hardware for OSPR), WO 2007/031797 (Adaptive Noise Cancellation Techniques), WO 2007/110668 (Lens Encoding), WO 2007/141567 (Colour Image Display), and WO 2008/120015 (Head Up Displays), all hereby incorporated by reference.

In a related aspect the invention provides a road vehicle contact-analogue head up display (HUD), the head up display comprising: a virtual image generation system to generate a virtual image for viewing at a virtual image distance of at least 5 metres; a sensor system input to receive sensed road position data defining a road position relative to said road vehicle, said road position data including data defining a lateral position of a road on which the vehicle is travelling relative to said road vehicle, and a vehicle pitch or horizon position; a symbol image generation system to generate symbology image data for contact-analogue display by said HUD; and an imagery processor coupled to said symbol image generation system, to said sensor system input and to said virtual image generation system, to receive said symbology image data for contact-analogue display and to process said symbology image data to convert said symbology image data to data defining an image dependent on said sensed road position data for input to said virtual image generation system, such that when said virtual image is viewed with said HUD the viewed virtual image appears to a viewer at a substantially fixed position relative to said road; and further comprising an occlusion sensor input to receive an occlusion detection signal and an occlusion detection processor coupled to said occlusion input to detect occlusion of part of said road in a field of view addressed by the head-up display, and wherein said imagery processor is responsive to said occlusion detection to modify said symbology image data for said viewer.

As previously mentioned, handling of occlusions is important to maintaining the credibility of the contact analogue display. The presence of an occlusion in front of the vehicle may be detected by processing an image captured by at least one light-based camera or by processing a radar image, which can be advantageous as features such as shadows do not appear as part of the occluding object. In simpler approaches, however, an occlusion detection signal may be derived from a radar (or camera) viewing in a 2D plane or along a 1D line acting as a pointer in front of the vehicle; optionally this may be scanned. Where radar is employed this will generally be radio frequency radar, although this is not essential.

Where the occlusion detection processor detects an occlusion of part of the driver's view in which symbology or graphical images would otherwise be presented the system has a choice of strategies. One strategy is to revert to a “flat” 2D display from which contact analogue cues are substantially absent. Another strategy is to clip the symbology/graphical elements using the shape of the detected occlusion so that the HUD image is not displayed over the occlusion. A third strategy is to combine the displayed symbology/graphical elements with the detected occlusion so that, for example, the symbology/graphical elements “behind” the occlusion are displayed in a modified form, for example, dimmer or in a different colour or using a dashed line; optionally a shadow onto the displayed symbology/graphics, resulting from the occlusion, can be added for greater reality. In some implementations, as previously described, the symbology image data may be 3-dimensional and a 3-dimensional representation of an occlusion may also be generated, to enable an occluded version of the symbology from the car/driver viewpoint to be generated. Although in general the view of the occlusion from the vehicle will be 2D projection of the 3D object, the 3D shape may be approximated, for example by assuming a uniform cross-section in depth.

In embodiments the contact analogue head-up display is configured not to detect occluding objects at greater than a threshold distance away from the vehicle, for example at a distance of no greater than 200 m, 150 m, 100 m, 75 m, or 50 m. Broadly speaking the threshold distance may be set (or adjusted dynamically) to correspond with a stopping distance for the vehicle, optionally with an additional safety margin of 50%, 100%, 200% or 300%. The use of such a threshold helps to reduce the incidence of false positive occlusion detection events.

Generally, preferred embodiments of the above described contact analogue HUD may employ features of embodiments of the previously described aspect of the invention. Thus, for example, some preferred embodiments of the display employ monocular cues as previously described.

### HUD Light Shields

According to a further aspect of the invention there is provided a head up display, the display comprising a virtual image generation system to generate a virtual image for presentation to an optical combiner to combine light exiting said image generation system bearing said virtual image with light from an external scene, for presentation of a combined image to a user, wherein said virtual image generation system has output optics including a partially reflecting optical surface, wherein an optical axis of said light exiting said image generation system is tilted with respect to a normal to said optical surface, defining a tilt angle of greater than zero degrees between said optical axis and said normal to said optical surface, and wherein said partially reflecting optical surface has an angular filter on an output side of said optical surface to attenuate external light reflected from said partially reflecting optical surface at greater than a threshold angle to said optical axis.

In embodiments by tilting the partially reflecting optical surface with respect to an optical axis of the light exiting the system a (maximum) field of view of the head up display can be preserved whilst attenuating reflected sunlight. Thus, in embodiments, light entering the system along the optical axis is reflected and substantially blocked from exiting the system, although light entering at an angle closer to the normal to the output optical surface than the optical axis may not be blocked, depending upon the degree of angular filtering and also on the type of angular filter employed. (In the baffle example described later whether or not a ray is blocked depends, in part, on spatial location of the ray with respect to the baffle, more particularly whether or not is close to a side of a tube of the baffle).

The output side of the optical surface, that is the surface adjacent to which the angular filter is located to selectively inhibit reflected light is, in embodiments, an output surface of an exit pupil expander of the head up display (in a direction of propagation of light from the image generator towards the viewer). Thus in some preferred embodiments the partially reflecting optical surface comprises a partially transmissive, planar mirror surface, in embodiments with a reflectance which has a reflectance which is at least 80% or 90% at a wavelength at in the visible region of the spectrum, more particularly between 400 nm and 700 nm; more particularly which has a reflectance which is at least 80% or 90% at one or more wavelengths used by the image source. However, as previously mentioned, even low reflectance surfaces can cause significant problems with reflected sunlight and embodiments of the above described approach are useful even when the output optical surface is, for example, a simple uncoated glass surface. In general the optical surface to which the angular filter is applied will be a final optical surface of the optical surface of the head up display (apart from the combiner), but nonetheless some benefit can be obtained from the technique by employing a tilting optical surface and angular filter at an internal optical surface of the display—although this can be less effective at inhibiting sunlight reflections (and may require a larger volume assembly), it can still be useful in reducing sun-related damage. In embodiments employing our planar, waveguiding—type pupil expander the rear or internal optical surface of the waveguide generally has a very high reflectivity, for example greater than 95% or 98%, and hence even if the front surface is not mirrored reflection will result from the internal, rear surface of the waveguide.

In embodiments of the head up display the threshold angle is substantially equal to the aforementioned tilt angle—that is the angle between the optical axis and the perpendicular to the output optical surface defines the cut off angle of the angular filter (a skilled person will appreciate that the angular filter may not have a sharp cutoff, in which case the cutoff angle may be defined, for example, as a 3 dB point on the attenuation—angle curve). In embodiments the tilt angle of the optical surface is at least 3°, 5°, 10° or 15°; more typically the tilt angle is in the range 15-45°, again particularly where our parallel plate pupil expander is employed (in principle, however, an additional optical surface could be included in the head up display after the last optical element (apart from the combiner), merely for the purpose of sunlight attenuation by angular filtering.

In embodiments of the system the threshold angle is substantially equal to half a maximum field of view (FOV) of the head up display (more precisely, of the head up display without the angular filter). This angle will be less than the tilt angle for a pupil expander of the type we describe. In practice, whether or not it is desirable to entirely block reflections of light from the system depends, in part, on the type of angular filter employed as described further below.

The skilled person will appreciate that many different types of angular filter may be employed. For example the angular filter may comprise a dielectric stack coating (such coatings have an acceptance angle which, in effect, operates as an angular filter). Alternatively a reflective polariser may be employed (for example of the type available from Moxtek inc, USA), or a diffractive optical element, or microprisms, or a TIR (totally internally reflecting) light trap may be employed in front of the reflecting surface, or a multilayer (volume) hologram may be used. In some particularly preferred embodiments, however, the angular filter comprises an array of tubes, in particular, each extending longitudinally along the optical axis. As described in more detail later, such an arrangement is able to attenuate substantially reflections at all angles above a threshold angle, but also the degree of blocking depends upon the point of incidence of a ray of light on the array of tubes. Similarly, for light exiting the head up display through the array of tubes, for a ray incident just inside the edge of a tube, effectively half the field of view is blocked by the outer side of the tube. Because of this it can be desirable to pass more light than the field of view of the head up display, to avoid losing light at these points of incidence. Thus in embodiments where the angular filter comprises an array of tubes it can be desirable not to entirely block or trap light outside a field of view of the display, for improved light output efficiency (to avoid the field of view dimming towards the edge). One advantage of employing an array of tubes as the angular filter is that this is inexpensive and easy to fabricate, as well as being effective.

According to a related aspect of the invention there is therefore provided a head up display, the display comprising a virtual image generation system to generate a virtual image for presentation to an optical combiner to combine light exiting said image generation system bearing said virtual image with light from an external scene, for presentation of a combined image to a user, wherein said virtual image generation system has output optics including a partially reflecting optical surface, wherein an optical axis of said light exiting said image generation system is tilted with respect to a normal to said optical surface, defining a tilt angle of greater than zero degrees between said optical axis and said normal to said optical surface, and wherein said partially reflecting optical surface has a baffle adjacent said optical surface, said baffle comprising an arrange of tubes each extending longitudinally along said optical axis of said light exiting said image generation system.

In embodiments a tube has a longitudinal length (h) which is sufficiently long for light entering the HUD along the optical axis at the edge of a tube (parallel to a side wall of the tube) to be substantially blocked by the (opposite) side wall of the tube. It will be appreciated that light parallel to the optical axis at the edge of a tube is a worst case for this given incidence—incoming light at the centre of a tube imposes less of a constraint on the tube height (length) h. More particularly the constraint is that a ratio of a longitudinal length of the tube to a maximum lateral internal dimension of the tube is sufficiently large for incoming light parallel to the optical axis at the edge of the tube, which is reflected at the tilt angle, to be blocked by the opposite side wall of the tube. This defines a minimum longitudinal length or height of a tube. Still more particularly a ray of light parallel to the optical axis incident anywhere along the edge of a tube should be blocked (depending upon the shape of the tube cross-section and orientation with respect to the reflecting surface this may include a corner-to-corner reflection within a tube: a ray as previously described at the edge of a tube, in a corner, if present, should also be blocked). In embodiments, therefore, a longitudinal length h, of a (each) tube satisfies the constraint:

$$h > d max \cdot ( \frac{1}{tan 2 α} + tan α )$$

where dₘₐₓ is a maximum internal lateral dimension of the tube and α is the tilt angle.

In embodiments at least some light off the optical axis, more particularly at an angle to the optical axis equal to or greater than the tilt angle which is incident at the centre of a tube is reflected such that it is substantially blocked by a side wall of the tube. Thus, in embodiments, light incident at the centre of a tube at greater than a tilt angle is blocked. Preferably the tubes are long enough such that at least some light incident at the centre of the tube at greater than a half field of view angle of the HUD is blocked. In embodiments the tubes may be sufficiently long to block substantially all reflections from the output surface of the HUD (though this is a much more stringent condition than the previous inequality and reduces the optical transmission of the system). In embodiments the length of a tube may thus satisfy the further constraint that:

$$h > \frac{d max}{cos α \cdot sin α}$$

In embodiments a tube has a minimum lateral internal dimension which is sufficiently large for a field of view of the head up display to be substantially unrestricted by the baffle. More particularly a ratio of the minimum lateral internal dimension to the length of a tube is sufficiently large for a (maximum) field of view of the HUD to be substantially unrestricted (the FOV may be different in different directions). Thus in embodiments the FOV is effectively unrestricted by the baffle. In embodiments, therefore, the minimum lateral internal dimension dₘᵢₙ satisfies the constraint:

$$h \leq \frac{{d}_{min}}{2} \cdot ( \frac{1}{tan ( FOV / 2 )} - tan α )$$

The baffle is not located at an image plane, so that it is not directly perceptible when observing a virtual image significantly further in the distance. However it may, nonetheless, have a perceptible effect on the viewed image. For this reason a non-rectangular tube cross-section is preferable as having a different symmetry to the rectangular symmetry of the display helps reduce the perceptibility of any artefacts arising from the baffle. In embodiments the cross-section of a tube may therefore be substantially hexagonal, and the tubes may be substantially close-packed. In other embodiments, however, the cross-section of a tube may be substantially square or rectangular.

As previously mentioned, in embodiments the partially reflecting surface is a final output optical surface of the output optics of the HUD (the output optics here not being considered as including the combiner, that is a combining optical surface, such as a vehicle windscreen, which combines the image from the HUD with an external scene). This is advantageous for inhibiting sunlight reflections from the HUD. As previously mentioned, in preferred embodiments the output optics comprise exit pupil expander optics.

The exit pupil expander optics preferably comprise image replication optics comprising a pair of substantially planar reflecting optical surfaces defining substantially parallel planes spaced apart in a direction perpendicular to the parallel planes, a first, front optical surface and a second, rear optical surface. The image generation system is configured to launch a collimated beam into a region between the parallel planes. A small divergence, for example up to 3°, may be tolerated, especially if the image replication optics is located relatively close to the spatial light modulator (in a holographic image display system). The beam is launched at an angle to the normal to the parallel, reflecting planes, for example at greater than 15 degrees, 30 degrees, 45 degrees or more to this normal, such that the reflecting optical surfaces waveguide the beam in a plurality of successive reflections between the surfaces. The front optical surface is a partially transmitting mirrored surface, to transmit a proportion of the collimated beam when reflecting the beam such that at each reflection at the front optical surface a replica of the image is output from these optics. The rear optical surface is a coated, mirrored surface.

The front optical surface may either transmit a first polarisation and reflect an orthogonal polarisation, or transmit a proportion of the incident light substantially irrespective of polarisation. In the first case a phase retarding layer is included between the reflecting optical surfaces such for each reflection from the rear surface (two passes through the phase retarding layer) a component of light at the first polarisation is introduced, which is transmitted through the front optical surface. In the second case the transmission of the partially transmitting mirror depends on the number of replicas desired—for example for four replicas, the mirror transmission is typically between 10% and 50%, but for ten or more replicas the range is typically in the range 0.1% to 10%.

Increased optical efficiency can be achieved by stacking two (or more) sets of image replication optics one above another so that a replicated beam from a first set of image replication optics provides an input beam to a second set of image replication optics (the latter preferably with a smaller spacing between the planar reflectors). This can be used to replicate beams in one dimension or in two dimensions.

In preferred embodiments the image generation system is a laser-based system comprising a laser light source illuminating image generating optics comprising a spatial light modulator (SLM), preferably a reflective SLM for compactness. There are many advantages of using a laser-based image generation system, especially when combined with a holographic image generation technique. However special problems are presented by laser-based image display systems because of the small etendue of laser sources. The etendue is preserved in a geometrical optical system and if a laser is employed to generate the light from which the image is produced, absent other strategies the etendue will be small, but in a laser-based image display system for a head-up display it is desirable to increase the etendue to increase the size of the region over which the displayed imagery may be viewed. An image replicator of the type we describe here is particularly useful to achieve this with a laser-based head up display.

In preferred embodiments the laser-based image generation system comprises a holographic image generation system, illuminating a spatial light modulator (SLM) with the laser light to generate a substantially collimated input beam for the pupil expander replication optics. Thus in embodiments a hologram generation processor drives the SLM with hologram data for the desired image. The processor converts input image data to target image data prior to converting this to a hologram, for a colour image compensating for the different scaling of the colour components of the multicolour projected image for replication when calculating this target image.

In some particularly preferred embodiments the processor is coupled to memory storing processor control code to implement and OSPR (One Step Phase Retrieval)—type procedure. Thus in embodiments an image is displayed by displaying a plurality of temporal holographic subframes on the SLM such that the corresponding projected images (each of which has the spatial extent of a replicated output beam) average in a viewer's eye to give the impression of a reduced noise version of the image for display. (It will be appreciated that for these purposes, video may be viewed as a succession of images for display, a plurality of temporal holographic subframes being provided for each image of the succession of images). We have previously described such techniques in, for example: WO 2005/059660 (Noise Suppression Using One Step Phase Retrieval), WO 2006/134398 (Hardware for OSPR), WO 2007/031797 (Adaptive Noise Cancellation Techniques), WO 2007/110668 (Lens Encoding), WO 2007/141567 (Colour Image Display), and WO 2008/120015 (Head Up Displays), all hereby incorporated by reference.

In a related aspect the invention provides a method of inhibiting reflections of incoming light in a head up display, the method comprising generating a substantially collimated light beam comprising a virtual image for display, said virtual image having a field of view, said light beam defining an optical axis; passing said light beam through a tilted partially reflective optical surface, a normal to said optical surface having a greater than zero angle to said optical axis; passing said light beam exiting said tilted optical surface through an optical angular filter to attenuate light at greater than a threshold angle to said optical axis; wherein light in said collimated beam within said field of view is substantially unattenuated by said angular filter, and wherein at least some incoming light incident on said tilted partially reflective optical surface through said optical angular filter is partially reflected back towards said angular filter at greater than said threshold angle and attenuated.

In embodiments the threshold angle is selected such that reflections of incoming light, in particular sunlight, from the partially reflective optical surface, where these reflections are at greater than the threshold angle to the optical axis, are trapped by the angular filter. In embodiments reflections at an angle greater than the angle of the normal to the optical surface to the optical axis are trapped. Thus in embodiments light entering the head up display along the optical axis is trapped by the angular filter.

There is a special situation where light exiting along the optical axis of the head up display is directed towards a mirror or a substantially reflecting surface. In such a case absent angular filtering light reflected from this external mirror can be re-injected into the head up display and replicated by the reflecting surfaces of the optics, causing the appearance of a ghost or echo image. In this situation the angular filter should at least block incoming light at an angle of twice the tilt angle of the system (that is twice the angle between the optical axis and the normal to the optical surface), since this is the angle at which incoming light reflected from the mirror arrives. In a similar way, in the previously described aspects and embodiments of the invention, in some implementations a threshold angle for attenuation or cutoff of reflections from the front optical surface of the head up display is twice the tilt angle of the optical surface.

In a further related aspect the invention provides a head up display including means for inhibiting reflections of incoming light, the head up display comprising means for generating a substantially collimated light beam comprising a virtual image for display, said virtual image having a field of view, said light beam defining an optical axis; wherein an optical path for said light beam in said device includes (passes through) a tilted partially reflective optical surface, a normal to said optical surface having a greater than zero angle to said optical axis; wherein, in an output direction, said optical path exits said tilted optical surface through an optical angular filter to attenuate light at greater than a threshold angle to said optical axis; and wherein light in said collimated beam within said field of view is substantially unattenuated by said angular filter, and wherein at least some incoming light incident on said tilted partially reflective optical surface through said optical angular filter is partially reflected back towards said angular filter at greater than said threshold angle and attenuated.

Embodiments of the above described aspects of the invention are particularly applicable to head up displays for road vehicles such as cars.

### BRIEF DESCRIPTION OF THE DRAWINGS

These and other aspects of the invention will now be further described, by way of example only, with reference to the accompanying figures in which:

FIG. 1 shows an example of a head-up display configured to present a virtual image to a driver at an apparent depth of around 2.5 m;

FIG. 2 shows a generalised optical system of a virtual image display using a holographic projector;

FIGS. 3a and 3b show, respectively a head-up display (HUD) incorporating a holographic image display system using an optical image replicator for an exit pupil expander, and stacked pupil expanders of the type illustrated in FIG. 3a, for expanding a beam in two dimensions;

FIGS. 4a to 4c show, respectively, a block diagram of a contact analogue HUD according to an embodiment of a first aspect of the invention, an example road sensing system, and an example driver sensing system;

FIG. 5 shows example contact analogue HUD symbology for an embodiment of the invention, applying monocular cues ((a) linear perspective, (b) texture gradient, (c) relative size, (d) relative height, (e) familiar size and (f) atmospheric perspective);

FIG. 6 shows symbology at a distance ‘a’ closer than a focus (collimation) distance ‘b’ of a virtual image of the HUD, according to an embodiment of the invention;

FIG. 7 shows contact analogue symbology generated by a HUD according to an embodiment of the invention;

FIG. 8 shows a modification to the block diagram of FIG. 4a for a contact analogue HUD according to an embodiment of a second aspect of the invention;

FIG. 9 shows an example of occlusion addressed by the system of FIG. 8: another user is in the field of view at a short distance and intercepting the representation of the perspective;

FIGS. 10a to 10d show, respectively, a block diagram of a hologram data calculation system, operations performed within the hardware block of the hologram data calculation system, energy spectra of a sample image before and after multiplication by a random phase matrix, and an example of a hologram data calculation system with parallel quantisers for the simultaneous generation of two sub-frames from real and imaginary components of complex holographic sub-frame data;

FIGS. 11a and 11b show, respectively, an outline block diagram of an adaptive OSPR-type system, and details of an example implementation of the system;

FIGS. 12a to 12c show, respectively, a colour holographic image projection system, and image, hologram (SLM) and display screen planes illustrating operation of the system;

FIG. 13 shows a functional representation of the pupil expansion based HUD of FIG. 3;

FIG. 14 shows a functional representation of the pupil expansion based HUD of FIG. 3 incorporating a reflected light shield according to an embodiment of the invention;

FIG. 15 shows a ray diagram illustrating reflection of light beams entering the system of FIG. 14 within the angular filtering of the field of view;

FIGS. 16a and 16b show an example of a shutter or baffle-based light shield according to an embodiment of the invention comprising an array of square base oblique (α=30°) tubular prisms;

FIG. 17 shows a ray diagram for determining a condition that the full field of view should at least be visible from the centre of each cell of a shutter or baffle of the type shown in FIG. 16 when employed in a HUD as illustrated in FIG. 14;

FIGS. 18a and 18b show a ray diagrams for determining, respectively, a condition that incoming rays parallel to the optical axis are fully blocked, and a condition that no incoming light can escape the optical system after reflection from the front reflecting surface;

FIGS. 19a and 19b show, respectively, a simplified ray diagram for the HUD of FIG. 14, and a characterisation of the angular filtering for a generalised HUD of type shown in FIG. 14 in which a generalised angular filter is employed;

FIGS. 20a to 20c show, respectively, a ray diagram for reflection of an incoming ray for the HUD of FIG. 14, a characterisation of the possible range of angles of the emerging reflected rays given a generalised angular filtering applied on the incoming rays, and a diagrammatic illustration of a condition on the angular filtering for no reflected incoming ray to emerge from the HUD; and

FIG. 21 illustrates a use-case of the HUD of FIG. 14 where the HUD projects an image towards a mirror.

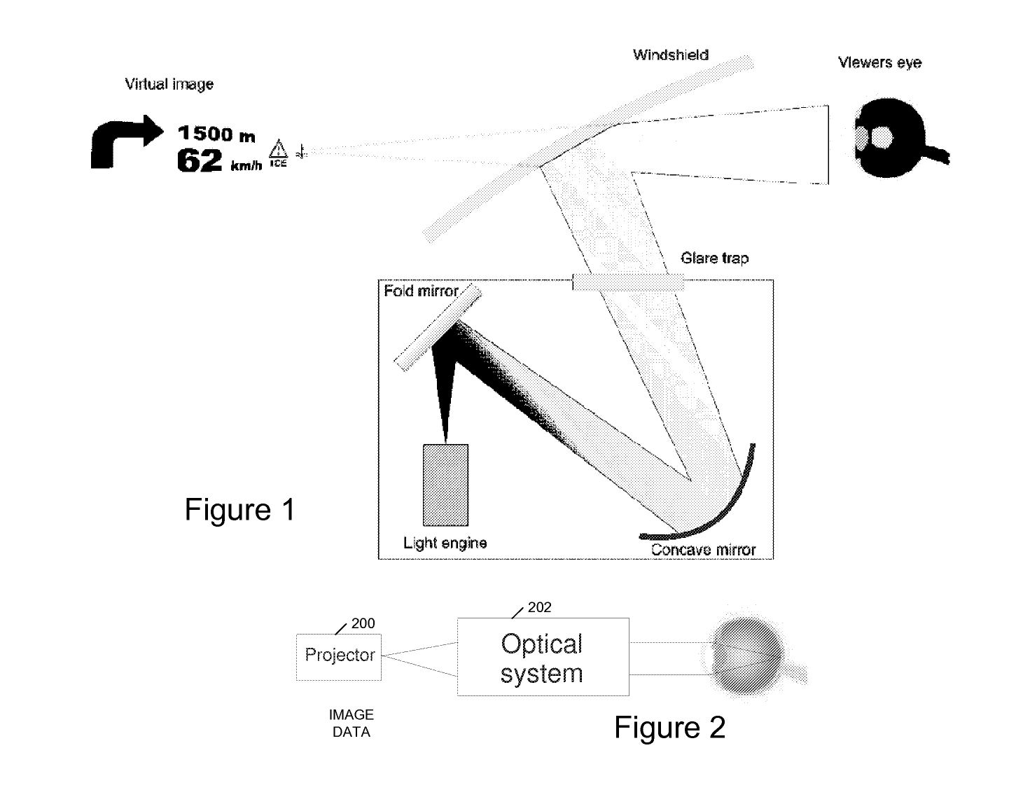

### DETAILED DESCRIPTION OF PREFERRED EMBODIMENTS

A virtual image display provides imagery in which the focus distance of the projected image is some distance behind the projection surface, thereby giving the effect of depth. A general arrangement of such a system includes, but is not limited to, the components shown in FIG. 2. A projector 200 is used as the image source, and an optical system 202 is employed to control the focus distance at the viewer's retina 204, thereby providing a virtual image display.

To aid in understanding background and context for the description of preferred embodiments of the head up display systems we describe it is helpful first to outline one example of a preferred head up display, although use of an HUD of this type is not essential. The HUD we will describe uses a laser-based system to generate an image for display, more particularly an image generator which generates an image by calculating a hologram for the image and displaying this on an SLM. The skilled person will, however, appreciate from the later description that such laser-based (and more specifically, hologram-based) techniques are not essential according to embodiments of aspects of the invention, albeit they have particular advantages for automotive HUDs.

### Head-Up Displays

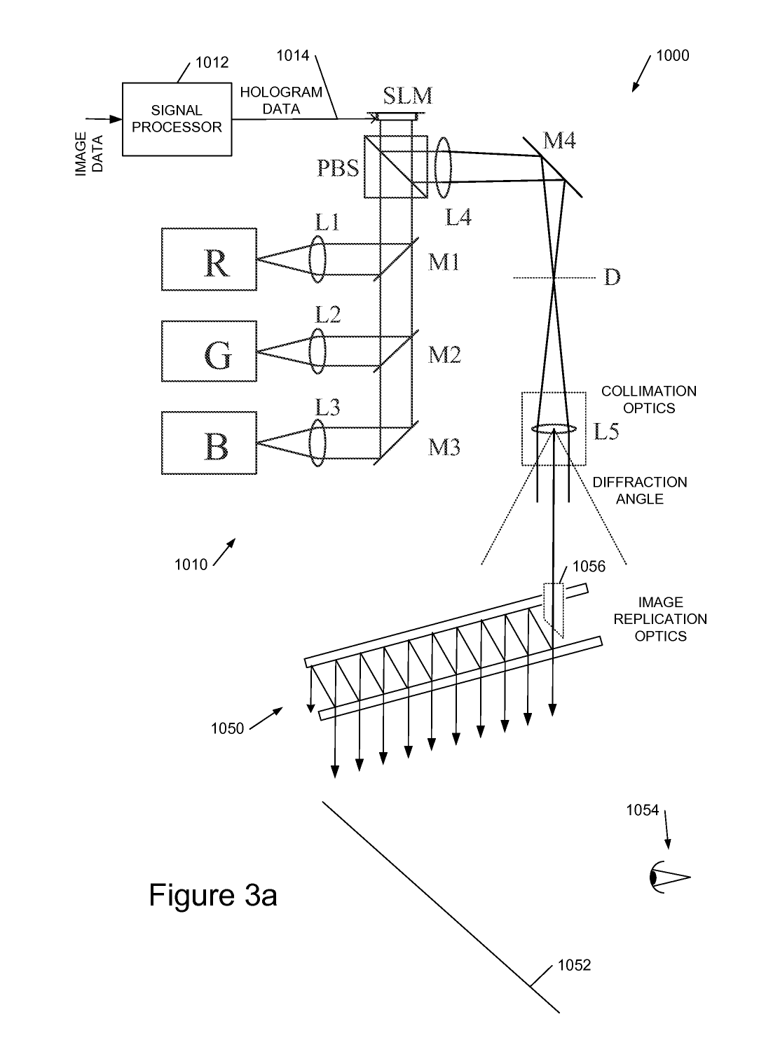

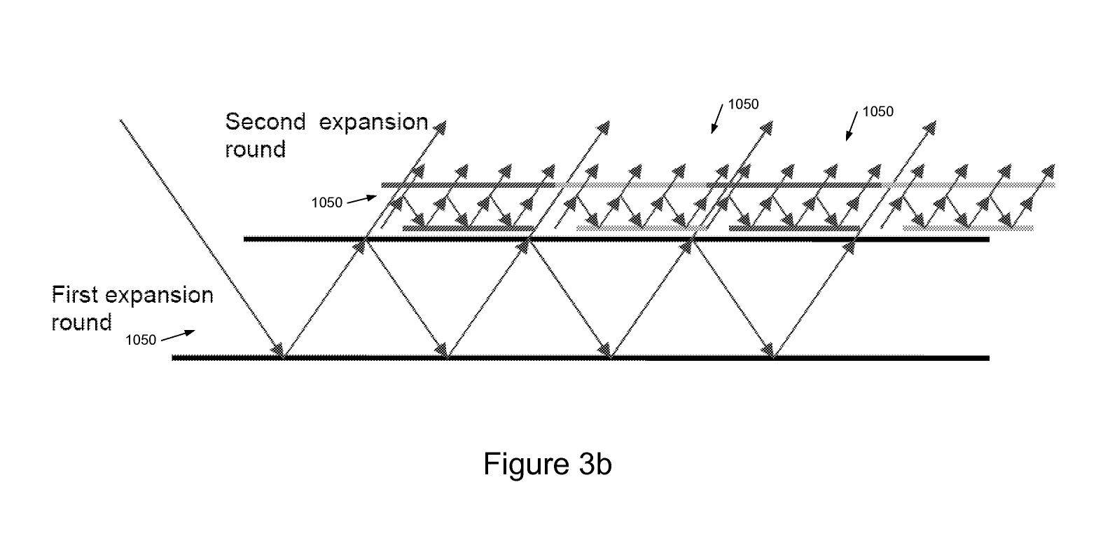

Referring now to FIG. 3a, this shows an example of a head-up display (HUD) 1000 comprising a preferred holographic image projection system 1010 in combination with image replication optics 1050 and a final, semi-reflective optical element 1052 to combine the replicated images with an external view, for example for a cockpit display for a car driver 1054

As illustrated the holographic image projection system 1010 provides a polarised collimated beam to the image replication optics (through an aperture in the rear mirror), which in turn provides a plurality of replicated images for viewing by user 1054 via a combiner element 1052 which may comprise, for example, a chromatic mirror or the windscreen of a car (where the element is curved the hologram may be calculated for distortion introduced by reflection from this element). The back optical surface of the image replication optics 1050 typically has a very high reflectivity, for example better than 95%.

In the example holographic image projector 1010 there are red R, green G, and blue B lasers and the following additional elements:
SLM is the hologram SLM (spatial light modulator). In embodiments the SLM may be a liquid crystal device. Alternatively, other SLM technologies to effect phase modulation may be employed, such as a pixelated MEMS-based piston actuator device.
L1, L2 and L3 are collimation lenses for the R, G and B lasers respectively (optional, depending upon the laser output).
M1, M2 and M3 are corresponding dichroic mirrors.
PBS (Polarising Beam Splitter) transmits the incident illumination to the SLM. Diffracted light produced by the SLM—naturally rotated (with a liquid crystal SLM) in polarisation by 90 degrees—is then reflected by the PBS towards L4.
Mirror M4 folds the optical path.
Lenses L4 and L5 form an output telescope (demagnifying optics), as with holographic projectors we have previously described. The output projection angle is proportional to the ratio of the focal length of L4 to that of L5. In embodiments L4 may be encoded into the hologram(s) on the SLM, for example using the techniques we have described in WO2007/110668, and/or output lens L5 may be replaced by a group of projection lenses. Optionally a diffuser may be incorporated at an intermediate image plane, as shown by dashed line D.
A system controller 1012 performs signal processing, in either dedicated hardware, or in software, or in a combination of the two, to generate hologram data from input image data. Thus controller 1012 inputs image data and touch sensed data and provides hologram data 1014 to the SLM. The controller also provides laser light intensity control data to each of the three lasers to control the overall laser power in the image.

An alternative technique for coupling the output beam from the image projection system into the image replication optics employs a waveguide 1056, shown dashed in FIG. 3a. This captures the light from the image projection system and has an angled end within the image replication optics waveguide to facilitate release of the captured light into the image replication optics waveguide. Use of an image injection element 1056 of this type facilitates capture of input light to the image replication optics over a range of angles, and hence facilitates matching the image projection optics to the image replication optics.

The arrangement of FIG. 3a illustrates a system in which symbology (or any video content) from the head-up display is combined with an external view to provide a head-up display within a vehicle. The eye-box is expanded to provide a larger exit pupil using a pair of planar, parallel reflecting surfaces to provide an image replicator located at any convenient point after a final optical element of the virtual image generation system, as previously described in our patent application number GB 0902468.8 filed 16 Feb. 2009.

FIG. 3b this shows stacked pupil expanders 1050 for expanding a beam in two dimensions: each output beam from the first image replicator is itself replicated by a second image replicator. As illustrated the second image replicators perform replication in the same direction as the first but for two-dimensional replication the second replicators may be rotated by 90° with respect to the configuration shown.

### Contact Analogue Head-Up Displays

In a contact analogue HUD the viewer perceives the displayed imagery as a part of the real world and in a substantially fixed position with reference to the real world environment. Applications for displaying contact analogue imagery include: direction of the driver's attention in situations where there is a risk of an accident, marking of weaker road users, marking of road signs, night vision, and fading in trace-exact navigation references and representations of driver assistance systems. The result is akin to so-called augmented reality systems.

The image generation and projection technology we have described with reference to FIG. 3 produces a virtual image substantially at infinity. The skilled person will, however, be aware that alternative optical systems may be employed to achieve this, with special advantages for laser-based systems employing an exit pupil expander prior to the combiner. In embodiments of one aspect of the invention the technique we describe to provide a contact analogue (augmented reality) HUD is to display the virtual imagery at at least 6 m in front of the viewer's eyes, preferably at at least 50 m or substantially infinity. Then monocular depth information is added to the displayed content to vary the perceived depth and facilitate merging the display with the background scenery. The monocular cues which may be employed include perspective, relative size, familiar size, and depth from motion; details of some preferred monocular cues are given later. Binocular cues are decreasingly important for objects beyond about 6 m.

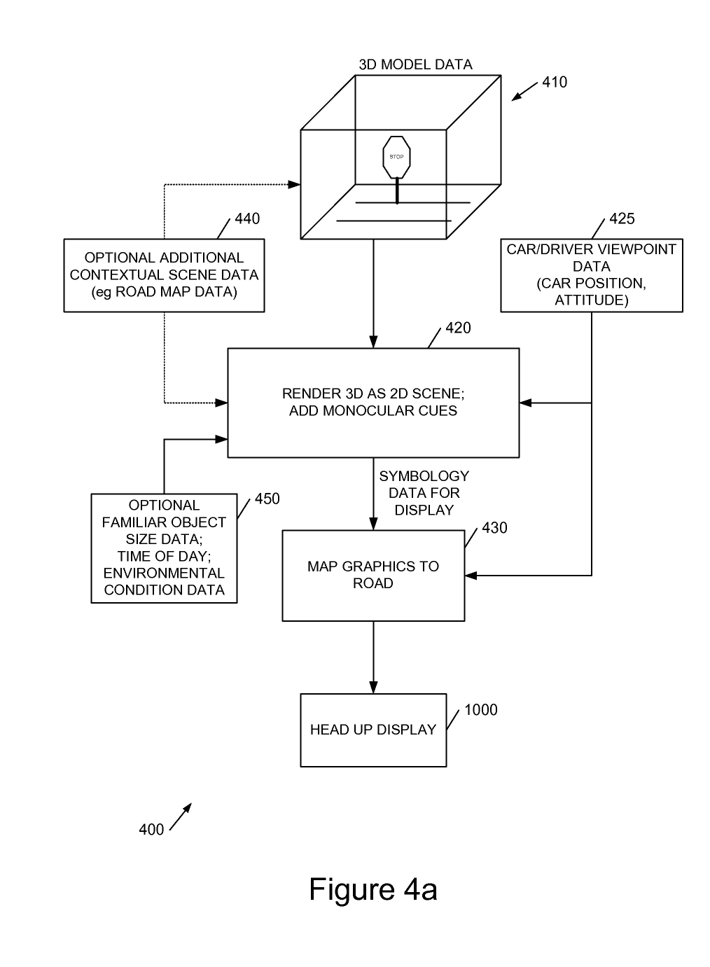

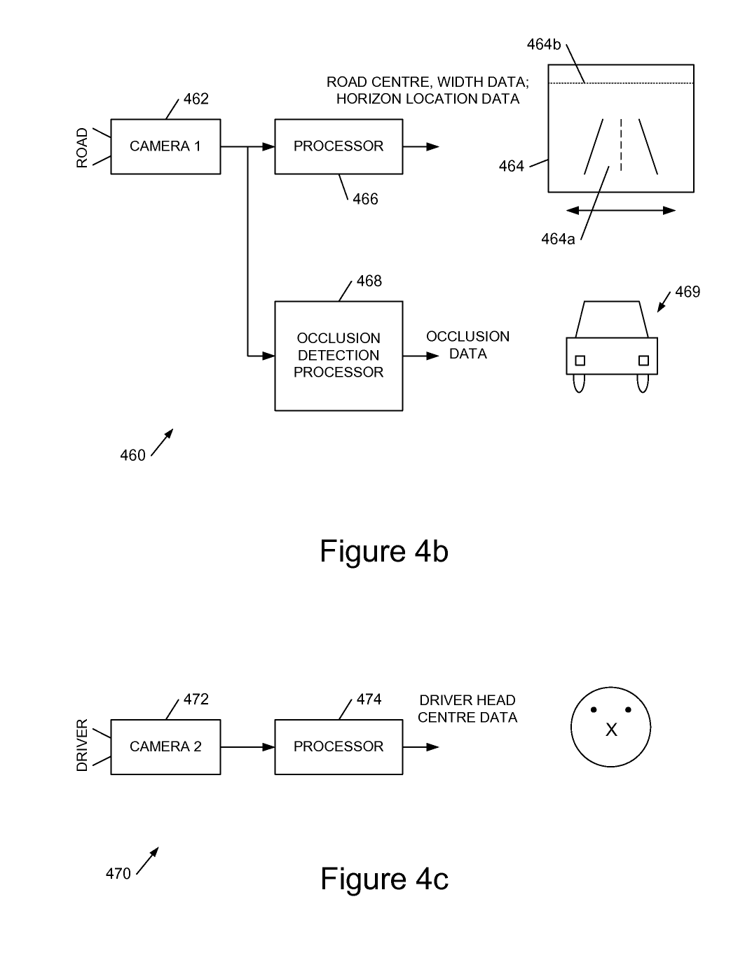

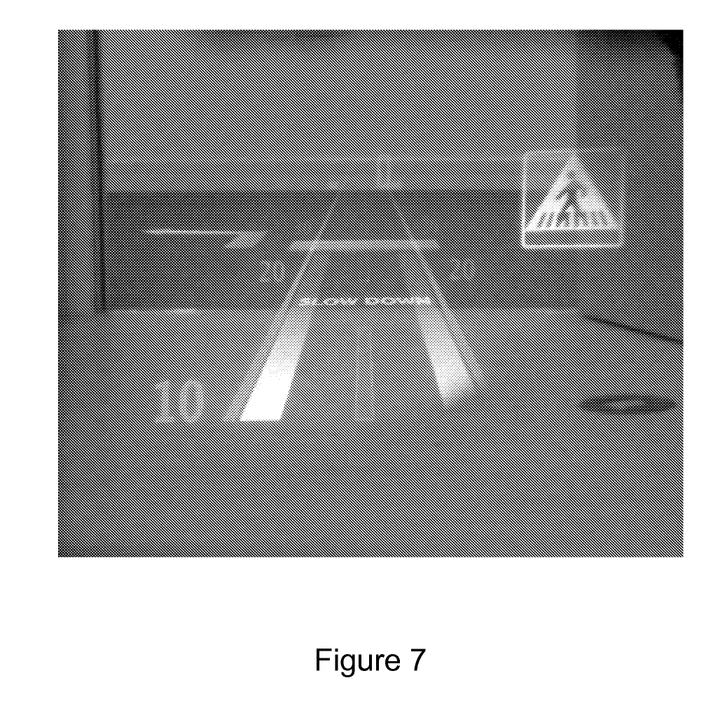

Referring now to FIG. 4a, this shows a block diagram of an embodiment of a contact analogue head-up display 400 according to an aspect of the invention. A 3D representation of the symbology 410 to be displayed provides an input to the system. This may include, for example, road signs, contextual data such as data indicating a turning, for navigation, and safety-related symbology. An example of the latter is a virtual vertical barrier at the stopping distance of the vehicle, as determined from road speed and, optionally, environmental conditions. The 3D model data 410 is provided to a processing stage 420 which renders the 3D model data as a 2D scene for display and adds monocular cues to the information to display, to encode visual depth information. The rendering is performed from the position and attitude of the car on the road and thus car (or driver) viewpoint data 430 provides an input for this procedure. In embodiments the rendering 420 inherently provides hidden surface removal, and adds perspective. Additional contextual scene data 440 may be added either into the 3D model data or during the rendering process 420. Once a 2D representation of the symbology for display has been generated (see FIG. 7, described later) this information is mapped to the road 430, again using the car position and attitude data. The symbology for display is then output for head-up display, for example using an HUD image generation system 1000 as previously described.

In embodiments monocular cue data 450 for use by the rendering process 420 includes familiar object size data, time of day, and environmental condition data. In this way the apparent size of a familiar object displayed in the contact analogue HUD can be used to define an apparent visual depth of the object, and object shadows can optionally be added based on time of day and the orientation of the sun direction; field dependent monocular cues may also be added selectively according to the level of illumination (for example day/night), depth of vision due to fog, rain and the like, and other environmental conditions. Broadly the apparent visual depth of an object to which a monocular cue such as a texture gradient or atmospheric perspective has been applied will depend upon the external conditions and thus by adjusting the degree to which the monocular cue is applied based on the external conditions a more accurate monocular depth cue is provided.

In general, the monocular cues (cues which provide depth information without requiring different images for each eye) which may be applied include the following:

Motion parallax—When an observer moves, the apparent relative motion of several stationary objects against a background gives information about their relative distance. If information about the direction and velocity of movement is known, motion parallax can provide absolute depth information. [Ferris, S. H. (1972). Motion parallax and absolute distance. Journal of experimental psychology, 95(2), 258-63].

Depth from motion—One form of depth from motion, kinetic depth perception, is determined by dynamically changing object size. As objects in motion become smaller, they appear to recede into the distance or move farther away; objects in motion that appear to be getting larger seem to be coming closer. Using kinetic depth perception enables the brain to calculate time to crash distance (time to collision or time to contact—TTC) at a particular velocity. When driving, we are constantly judging the dynamically changing headway (TTC) by kinetic depth perception.

Linear perspective—The property of parallel lines converging at infinity allows us to reconstruct the relative distance of two parts of an object, or of landscape features

Relative size—If two objects are known to be the same size (e.g., two trees) but their absolute size is unknown, relative size cues can provide information about the relative depth of the two objects. If one subtends a larger visual angle on the retina than the other, the object which subtends the larger visual angle appears closer.

Relative height—The closer an object is to the horizon the further away the object appears.

Familiar size—Since the visual angle of an object projected onto the retina decreases with distance, this information can be combined with previous knowledge of the objects size to determine the absolute depth of the object. For example, people are generally familiar with the size of an average automobile. This prior knowledge can be combined with information about the angle it subtends on the retina to determine the absolute depth of an automobile in a scene.

Texture gradient—Gradients result in a perception of depth as the spacing of the gradients' elements provides information about the distance at any point on the gradient. It also provides orientation information for surfaces and remains constant even if the observer changes position. [E. B. Goldstein (2002), Wahrnehmungs-psychologie, Spektrum Akademischer Verlag].

Atmospheric perspective—Due to particles (dust, water and the like) in the atmosphere objects which are far away appear to be less contrasted than closer objects.

Cast shadows—Size and shape of a shadow give information about depth and shape of a related object. The further a shadow moves from the object casting it, the further the object is perceived from the background. This assumes that position of the light source is known. [Kersten D, Mamassian P, Knill D C, 1997, “Moving cast shadows induce apparent motion in depth” Perception 26(2) 171-192].

Further background information can be found in: Bierbaumer, N., Schmidt, R. F.: Biologische Psychologie. Teil III. Springer, Berlin 2006.

Referring now to FIG. 4b, this shows one example of a road position detection system 460 which may be employed to generate the car viewpoint data 430 of FIG. 4a. In this example a camera 462 (which may already be present in the vehicle) is directed towards the road to capture an image 464 of the general type illustrated an image processor 466 processes this image to identify the lateral position of the car on the road 464a, for example by identifying the centre of the road, and to identify a location of the horizon 464b, either directly or by determining a vanishing point. Preferably also the width of the road is determined. This information (together with the known height of the vehicle, more particularly the driver's viewpoint) defines a location of the viewpoint in the coordinate system of the 3D symbology model. The attitude of the car especially the pitch of the car, determines the direction in which the 3D symbology model is viewed (this changes significantly with braking/acceleration).

FIG. 4c shows an example of a driver location identification system 470 comprising a camera 472 directed towards the driver coupled to an image processor 474 configured to identify a centre of the driver's head. Tracking the driver's head can be used to apply artificial parallax to the symbology to move one or more portions of the symbology with respect to another, based on the tracked head position, to give the impression of parallax.

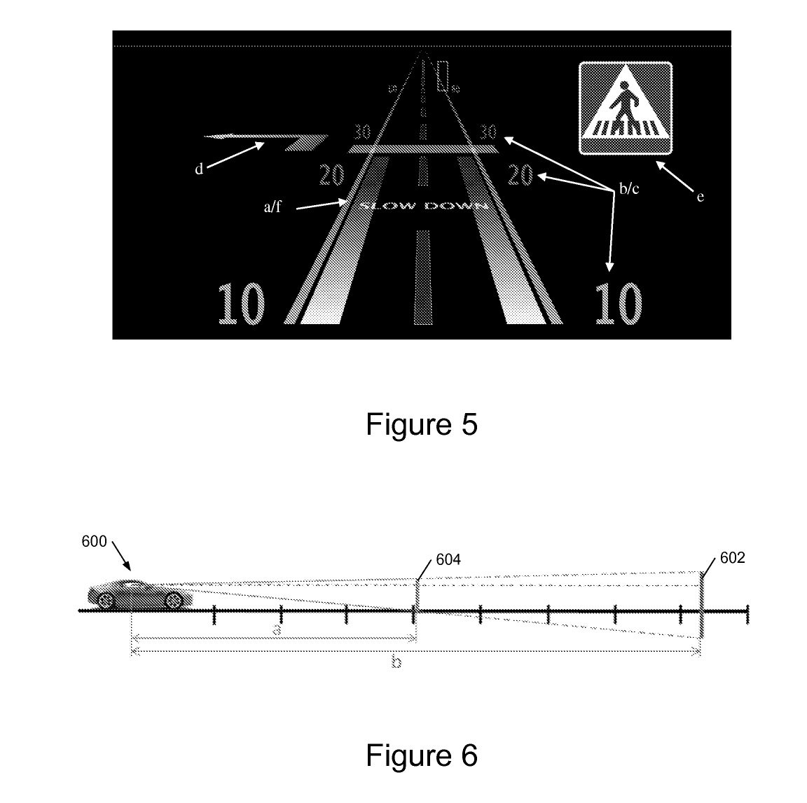

Referring now to FIG. 5, this shows an example of contact analogue symbology for display, incorporating a variety of monocular cues, in particular as described above: (a) linear perspective, (b) texture gradient, (c) relative size, (d) relative height, (e) familiar size and (f) atmospheric perspective, as labelled on the Figure.

Referring now to FIG. 6, this shows, schematically, a vehicle 600 fitted with a contact analogue HUD as described above configured to display a virtual image 602 at a focus distance (b) close to infinity. Monocular cues of the type shown in FIG. 5 are applied so that the perceived distance (a) of at least a portion of the symbology 604 is closer than the actual distance of the virtual image 602. In an example system, assuming a viewer (driver) position of 1.5 m above the ground level and a virtual image distance from 8.3 m to infinity (horizon), the equivalent field of view is approximately 10 degrees.

Referring now to FIG. 7, this shows experimental results achieved with a prototype contact analogue HUD as described above, using a holographic laser projector in combination with a mirror-based exit pupil expander. The monocular cues applied in this example image include relative (familiar) size and symbology perspective.

### Occlusion Detection

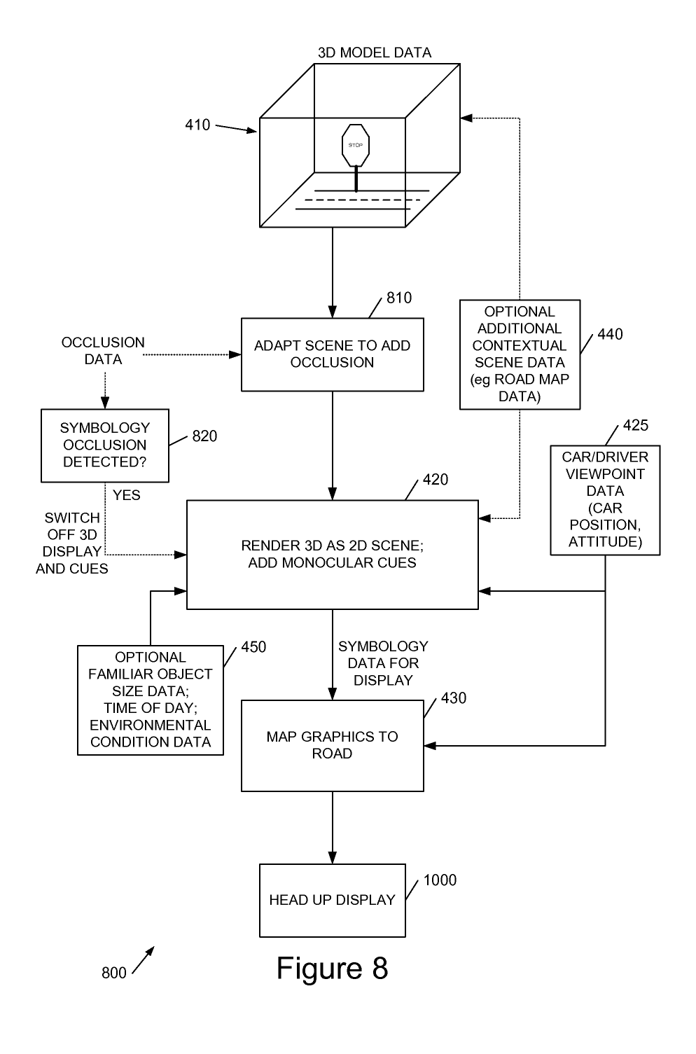

Referring now to FIG. 8, this shows a second example of a contact analogue head-up display 800 comprising a modification of the system shown in FIG. 4a (like elements are indicated by like reference numerals), incorporating occlusion detection. For an automotive contact analogue HUD objects are often relatively close and there is frequently a changing context resulting from other road users in the field of view. Preferred implementations of the HUD therefore include a system for the detection of occlusion.

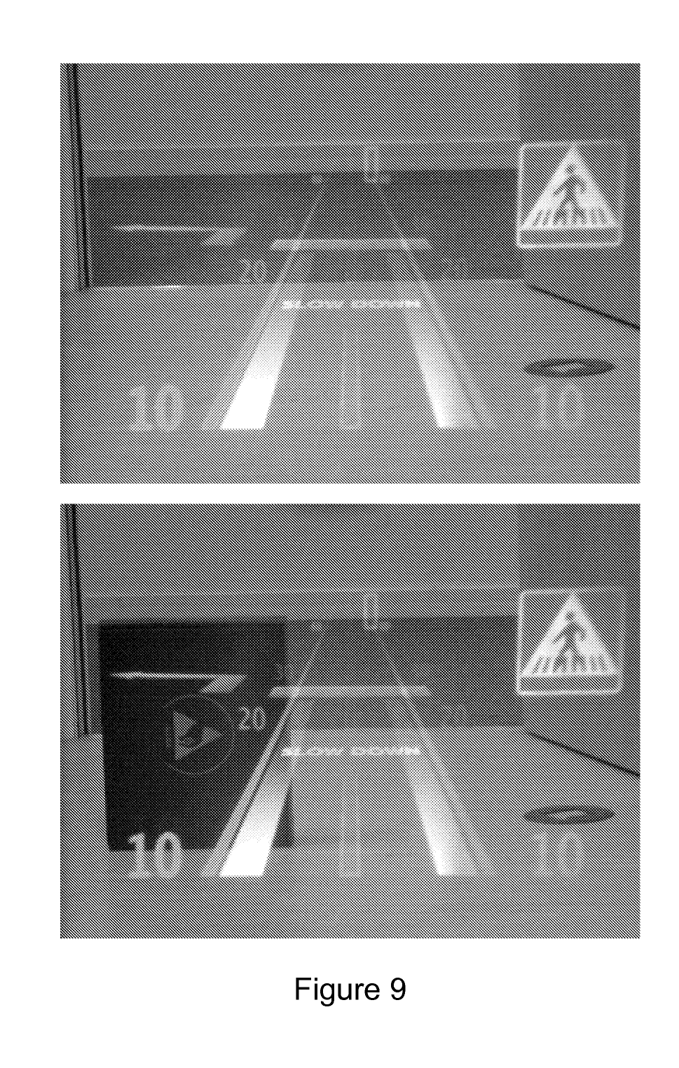

Occlusion occurs when an object, incidentally in the field of view, intercepts the information displayed, overlapping mapping of the displayed symbology to the scene without the object present. Thus it is desirable to adapt the information displayed in order to avoid confusing the driver. FIG. 9 shows an example of a contact analogue display without occlusion detection/processing, illustrating the problem to address: in the example of FIG. 9 one strategy to employ is to represent the track in different shades or colours and/or using dashed lines to illustrate that it passes under the vehicle. This increases the credibility of the representation, and its value to the driver. It will be appreciated that a range of strategies may be employed, from reverting to flat (not contact analogue) symbology when occlusion is detected, to merging the obstacle with the symbology or boxing/clipping the obstacle.

Referring again to FIG. 4b, in embodiments camera 462 provides an input to an occlusion detection processor 468 which identifies occlusions and provides an occlusion data output. This may comprise a simple binary occlusion detected/not detected signal or a more complex signal, for example an outline or quasi 3D image 469 of the occluder. The skilled person will be aware that a range of techniques may be employed for occlusion detection of this type including, of example, those described in patent applications US2009/0074311 and EP1394761A. In embodiments the occlusion detection is not limited to detecting moving vehicles and may also detect a stationary vehicle (for example, a car stopped at a junction), pedestrians and, optionally traffic signals and/or buildings and/or other occluders in the vicinity of the road. Optionally data from topographic databases may be incorporated into the occlusion detection procedure. The skilled person will also appreciate that occlusion detection need not employ a system of the type shown in FIG. 4b and instead a simpler system, for example a forward-looking radar in one-, two- or three-dimensions may be employed.

Referring again to FIG. 8, in one embodiment the occlusion data is used to adapt 810 the 3D symbology data to add the occlusion into the 3D data so that when this data is rendered 420 the 3D scene is automatically processed to remove occluded parts. The occluded symbology data may then be further processed as previously described. With such an approach and approximate 2D projection of the occlusion onto the view of camera 462 (which is similar to the view of the driver) is sufficient, although determination of a 3D representation of an occlusion can be helpful for more accurate rendering.

When rendering the occlusion in combination with the displayed symbology a range of approaches may be employed, as previously described, depending upon the processing power. The occluder may simply clip and occlude the graphics, hiding the information (which preserves the augmented reality illusion), or the graphics may be merged with the occluder, for example displaying a dashed line or reduced brightness/changed colour where the graphics are obscured. In a more sophisticated approach shadows (see, for example, FIG. 9) can be detected and either ignored or used to further modify the displayed symbology. For example a combination of radar and visual images can be used to differentiate between a shadow and a physical occluding object.

In another simpler approach, the occlusion data is processed 820 to determine whether there is occlusion of any symbology and, if so, the 3D display and monocular cues can be switched off in the rendering process 420 to provide simpler, flat content.

In embodiments, the occlusion data may comprise, additionally or alternatively to a 2D or 3D view of the occluder, one or more of the following: distance of the occluder; identification of whether or not the occluder is moving (either with respect to the vehicle or with respect to the ground); and a speed of motion of the occluder (either “radial” or lateral, for example for integration with pedestrian detection.

Although some implementations of the above described system employ 3D symbology model data it will be appreciated that this is not essential and that a contact analogue HUD of the type described above may be implemented using only 2D, or even 1D symbology data. For example the displayed symbology may comprise only a line (bar) or vertical plane at a distance from the driver determined by the stopping distance of the vehicle. In such a case the processing described above may implemented without a 3D model of the symbology.

### Hologram Generation

Some implementations of the invention use an OSPR-type hologram generation procedure, and we therefore describe examples of such procedures below. However where a hologram-based HUD is employed there is no restriction to such a hologram generation procedure and other types of hologram generation procedure may be employed including, but not limited to: a Gerchberg-Saxton procedure (R. W. Gerchberg and W. O. Saxton, “A practical algorithm for the determination of phase from image and diffraction plane pictures” Optik 35, 237-246 (1972)) or a variant thereof, Direct Binary Search (M. A. Seldowitz, J. P. Allebach and D. W. Sweeney, “Synthesis of digital holograms by direct binary search” Appl. Opt. 26, 2788-2798 (1987)), simulated annealing (see, for example, M. P. Dames, R. J. Dowling, P. McKee, and D. Wood, “Efficient optical elements to generate intensity weighted spot arrays: design and fabrication,” Appl. Opt. 30, 2685-2691 (1991)), or a POCS (Projection Onto Constrained Sets) procedure (see, for example, C.-H. Wu, C.-L. Chen, and M. A. Fiddy, “Iterative procedure for improved computer-generated-hologram reconstruction,” Appl. Opt. 32, 5135-(1993)).

### OSPR—Based Hologram Generation

It will be appreciated that the techniques we describe are not limited to HUDs employing a hologram-based image generation procedure. However, broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram, each of which spatially overlaps in the replay field (in embodiments each has the spatial extent of the displayed image).

Each sub-frame when viewed individually would appear relatively noisy because noise is added, for example by phase quantisation by the holographic transform of the image data. However when viewed in rapid succession the replay field images average together in the eye of a viewer to give the impression of a low noise image. The noise in successive temporal subframes may either be pseudo-random (substantially independent) or the noise in a subframe may be dependent on the noise in one or more earlier subframes, with the aim of at least partially cancelling this out, or a combination may be employed. Such a system can provide a visually high quality display even though each sub-frame, were it to be viewed separately, would appear relatively noisy.

The procedure is a method of generating, for each still or video frame I=I_{xy}, sets of N binary-phase holograms h⁽¹⁾ . . . h^{(N)}. In embodiments such sets of holograms may form replay fields that exhibit mutually independent additive noise. An example is shown below:

1. Let G_{xy}⁽ⁿ⁾=I_{xy}exp(jφ_{xy}⁽ⁿ⁾) where φ_{xy}⁽ⁿ⁾ is uniformly distributed between 0 and 2π for 1≦n≦N/2 and 1≦x, y≦m
2. Let gᵤᵥ⁽ⁿ⁾=F⁻¹[G_{xy}⁽ⁿ⁾] where F⁻¹ represents the two-dimensional inverse Fourier transform operator, for 1≦n≦N/2
3. Let mᵤᵥ⁽ⁿ⁾= [symbol] {gᵤᵥ⁽ⁿ⁾} for 1≦n≦N/2
4. Let mᵤᵥ^{(n+N/2)}=ℑ{gᵤᵥ⁽ⁿ⁾} for 1≦n≦N/2

### 5. Let

$${h}_{uv}^{( n )} = \{ \begin{matrix}- 1 & if {m}_{uv}^{( n )} < {Q}^{( n )} \\ + 1 & if {m}_{uv}^{( n )} \geq {Q}^{( n )}\end{matrix} \\ where {Q}^{( n )} = median ( {m}_{uv}^{( n )} ) and 1 \leq n \leq N .$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. The median value of mᵤᵥ⁽ⁿ⁾ may be assumed to be zero with minimal effect on perceived image quality.

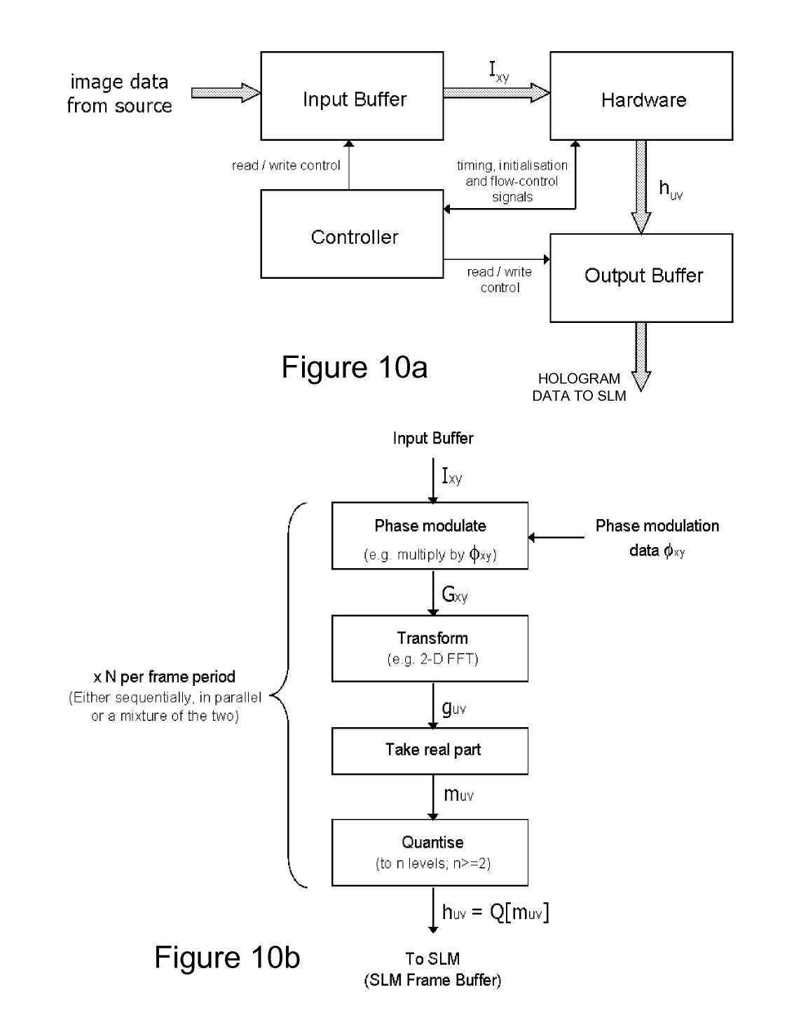

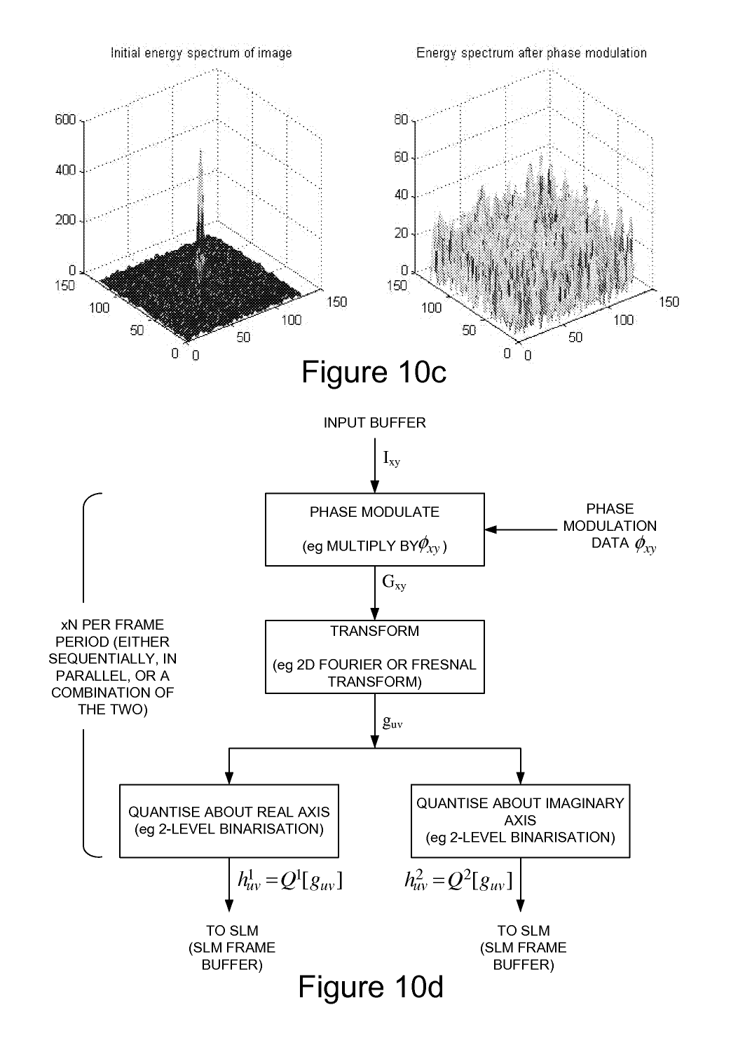

FIG. 10a, from our WO2006/134398, shows a block diagram of a hologram data calculation system configured to implement this procedure. The input to the system is preferably image data from a source such as a computer, although other sources are equally applicable. The input data is temporarily stored in one or more input buffer, with control signals for this process being supplied from one or more controller units within the system. The input (and output) buffers preferably comprise dual-port memory such that data may be written into the buffer and read out from the buffer simultaneously. The control signals comprise timing, initialisation and flow-control information and preferably ensure that one or more holographic sub-frames are produced and sent to the SLM per video frame period.

The output from the input comprises an image frame, labelled I, and this becomes the input to a hardware block (although in other embodiments some or all of the processing may be performed in software). The hardware block performs a series of operations on each of the aforementioned image frames, I, and for each one produces one or more holographic sub-frames, h, which are sent to one or more output buffer. The sub-frames are supplied from the output buffer to a display device, such as a SLM, optionally via a driver chip.

FIG. 10b shows details of the hardware block of FIG. 10a; this comprises a set of elements designed to generate one or more holographic sub-frames for each image frame that is supplied to the block. Preferably one image frame, I_{xy}, is supplied one or more times per video frame period as an input. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block is to redistribute the energy of the input frame in the spatial-frequency domain, such that improvements in final image quality are obtained after performing later operations. FIG. 10c shows an example of how the energy of a sample image is distributed before and after a phase-modulation stage in which a pseudo-random phase distribution is used. It can be seen that modulating an image by such a phase distribution has the effect of redistributing the energy more evenly throughout the spatial-frequency domain. The skilled person will appreciate that there are many ways in which pseudo-random binary-phase modulation data may be generated (for example, a shift register with feedback).

The quantisation block takes complex hologram data, which is produced as the output of the preceding space-frequency transform block, and maps it to a restricted set of values, which correspond to actual modulation levels that can be achieved on a target SLM (the different quantised phase retardation levels may need not have a regular distribution). The number of quantisation levels may be set at two, for example for an SLM producing phase retardations of 0 or π at each pixel.

In embodiments the quantiser is configured to separately quantise real and imaginary components of the holographic sub-frame data to generate a pair of holographic sub-frames, each with two (or more) phase-retardation levels, for the output buffer. FIG. 10d shows an example of such a system. It can be shown that for discretely pixelated fields, the real and imaginary components of the complex holographic sub-frame data are uncorrelated, which is why it is valid to treat the real and imaginary components independently and produce two uncorrelated holographic sub-frames.

An example of a suitable binary phase SLM is the SXGA (1280×1024) reflective binary phase modulating ferroelectric liquid crystal SLM made by CRL Opto (Forth Dimension Displays Limited, of Scotland, UK). A ferroelectric liquid crystal SLM is advantageous because of its fast switching time. Binary phase devices are convenient but some preferred embodiments of the method use so-called multiphase spatial light modulators as distinct from binary phase spatial light modulators (that is SLMs which have more than two different selectable phase delay values for a pixel as opposed to binary devices in which a pixel has only one of two phase delay values). Multiphase SLMs (devices with three or more quantized phases) include continuous phase SLMs, although when driven by digital circuitry these devices are necessarily quantised to a number of discrete phase delay values. Binary quantization results in a conjugate image whereas the use of more than binary phase suppresses the conjugate image (see WO 2005/059660).

### Adaptive OSPR

In the OSPR approach we have described above subframe holograms are generated independently and thus exhibit independent noise. In control terms, this is an open-loop system. However one might expect that better results could be obtained if, instead, the generation process for each subframe took into account the noise generated by the previous subframes in order to cancel it out, effectively “feeding back” the perceived image formed after, say, n OSPR frames to stage n+1 of the algorithm. In control terms, this is a closed-loop system.

One example of this approach comprises an adaptive OSPR algorithm which uses feedback as follows: each stage n of the algorithm calculates the noise resulting from the previously-generated holograms H₁ to Hₙ₋₁, and factors this noise into the generation of the hologram Hₙ to cancel it out. As a result, it can be shown that noise variance falls as 1/N². An example procedure takes as input a target image T, and a parameter N specifying the desired number of hologram subframes to produce, and outputs a set of N holograms H₁ to H_{N} which, when displayed sequentially at an appropriate rate, form as a far-field image a visual representation of T which is perceived as high quality:

An optional pre-processing step performs gamma correction to match a CRT display by calculating T (x, y)^{1.3}. Then at each stage n (of N stages) an array F (zero at the procedure start) keeps track of a “running total” (desired image, plus noise) of the image energy formed by the previous holograms H₁ to Hₙ₋₁ so that the noise may be evaluated and taken into account in the subsequent stage: F(x, y):=F(x, y)+| [symbol] [Hₙ₋₁(x, y)]|². A random phase factor φ is added at each stage to each pixel of the target image, and the target image is adjusted to take the noise from the previous stages into account, calculating a scaling factor α to match the intensity of the noisy “running total” energy F with the target image energy (T′)². The total noise energy from the previous n−1 stages is given by a F−(n−1)(T′)², according to the relation

$$α := \frac{{\sum }_{x , y} {{T}^{′} ( x , y )}^{4}}{{\sum }_{x , y} F ( x , y ) \cdot {{T}^{′} ( x , y )}^{2}}$$

and therefore the target energy at this stage is given by the difference between the desired target energy at this iteration and the previous noise present in order to cancel that noise out, i.e. (T′)²−[αF−(n−1)(T′)²]=n(T∝)²+αF. This gives a target amplitude |T″| equal to the square root of this energy value, i.e.

$${T}^{″} ( x , y ) := \{ \begin{matrix}\sqrt{2 {{T}^{′} ( x , y )}^{2} - α F} \cdot exp \{ jφ ( x , y ) \} & if 2 {{T}^{′} ( x , y )}^{2} > α F \\ 0 & otherwise\end{matrix}$$

At each stage n, H represents an intermediate fully-complex hologram formed from the target T″ and is calculated using an inverse Fourier transform operation. It is quantized to binary phase to form the output hologram Hₙ, i.e.

$$H ( x , y ) := {ℱ}^{- 1} [ {T}^{″} ( x , y ) ]$$

$${H}_{n} ( x , y ) = \{ \begin{matrix}1 & if Re [ H ( x , y ) ] > 0 \\ - 1 & otherwise\end{matrix}$$

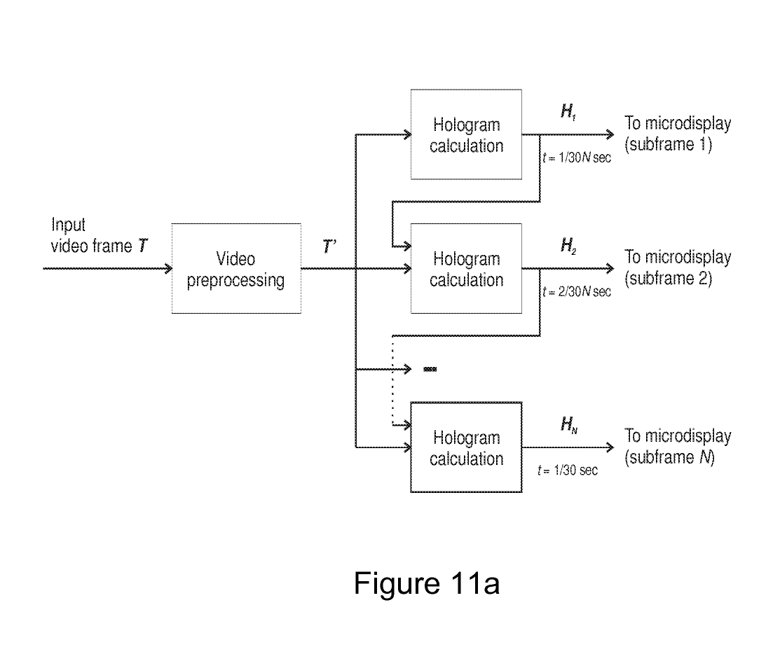

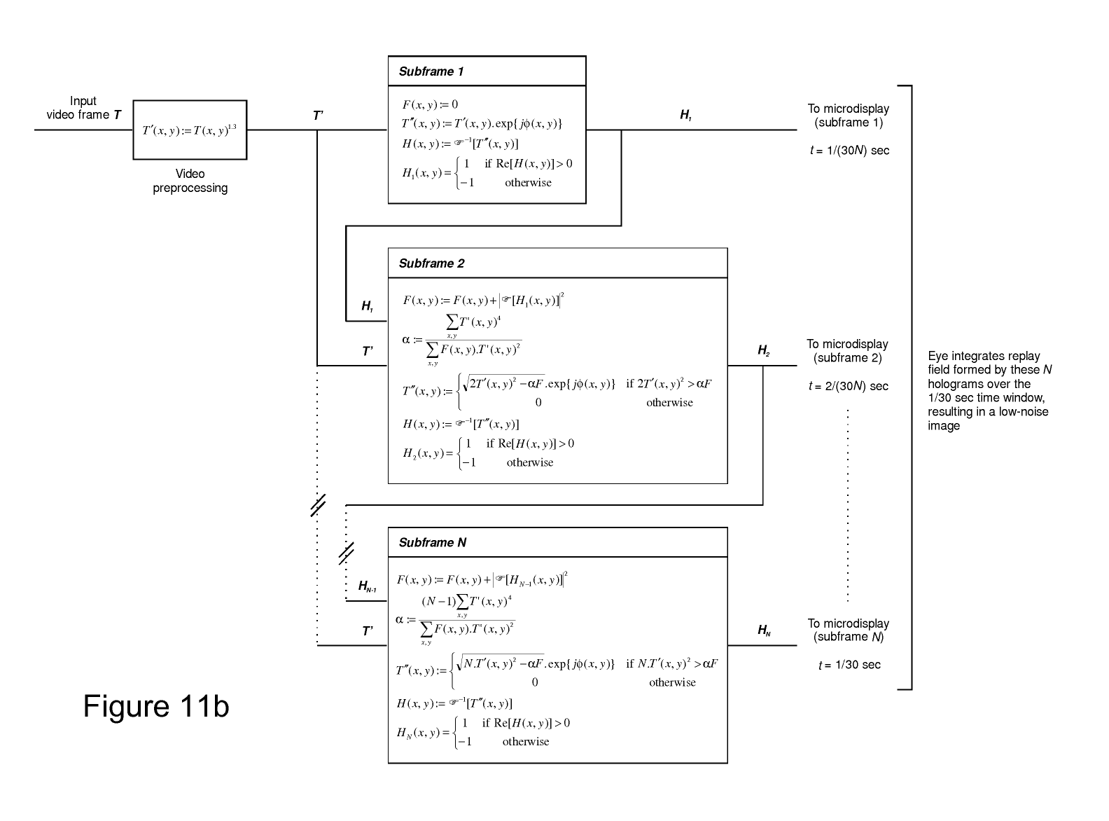

FIG. 11a outlines this method and FIG. 11b shows details of an example implementation, as described above.

Thus, broadly speaking, an ADOSPR-type method of generating data for displaying an image (defined by displayed image data, using a plurality of holographically generated temporal subframes displayed sequentially in time such that they are perceived as a single noise-reduced image), comprises generating from the displayed image data holographic data for each subframe such that replay of these gives the appearance of the image, and, when generating holographic data for a subframe, compensating for noise in the displayed image arising from one or more previous subframes of the sequence of holographically generated subframes. In embodiments the compensating comprises determining a noise compensation frame for a subframe; and determining an adjusted version of the displayed image data using the noise compensation frame, prior to generation of holographic data for a subframe. In embodiments the adjusting comprises transforming the previous subframe data from a frequency domain to a spatial domain, and subtracting the transformed data from data derived from the displayed image data.

More details, including a hardware implementation, can be found in WO2007/141567 hereby incorporated by reference.

### Colour Holographic Image Projection

The total field size of an image scales with the wavelength of light employed to illuminate the SLM, red light being diffracted more by the pixels of the SLM than blue light and thus giving rise to a larger total field size.

Naively a colour holographic projection system could be constructed by superimposed simply three optical channels, red, blue and green but this is difficult because the different colour images must be aligned. A better approach is to create a combined beam comprising red, green and blue light and provide this to a common SLM, scaling the sizes of the images to match one another.

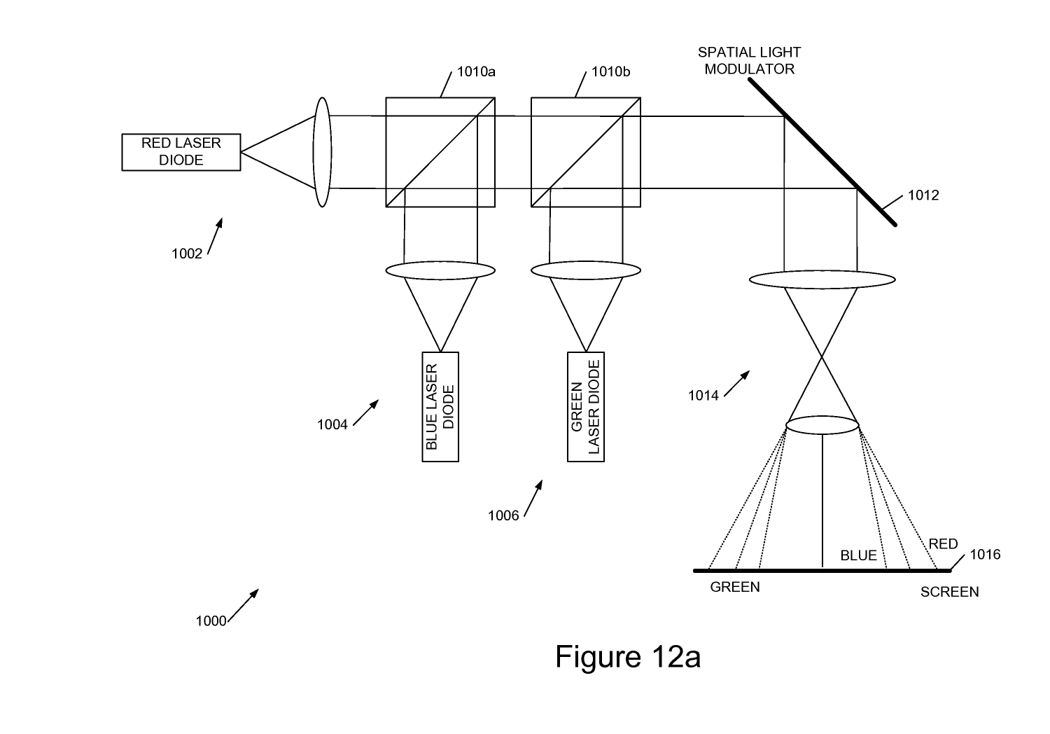

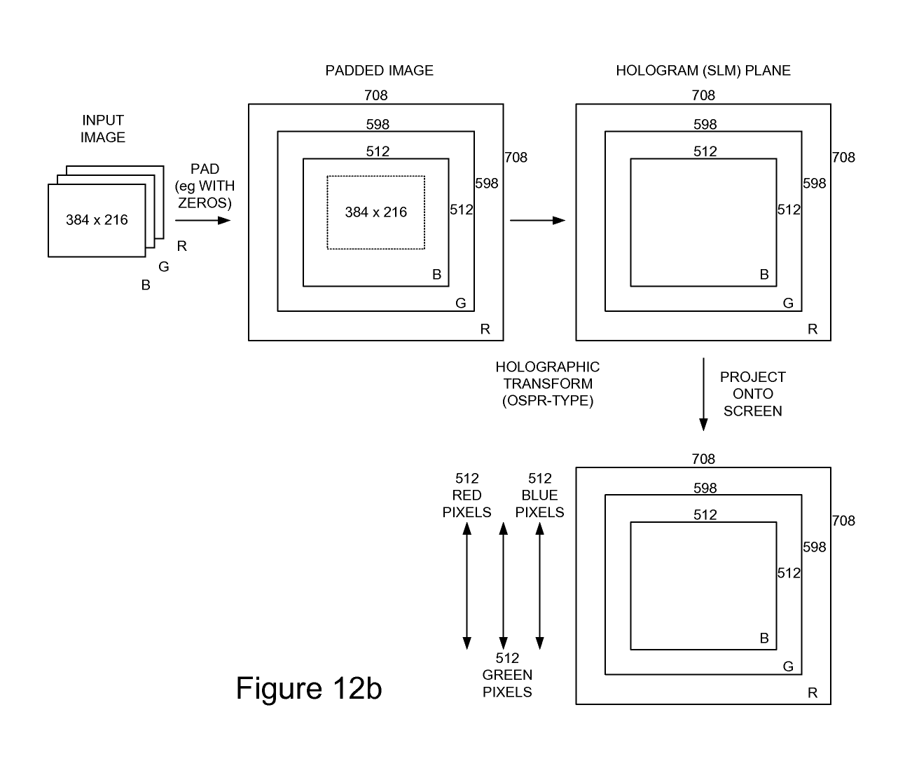

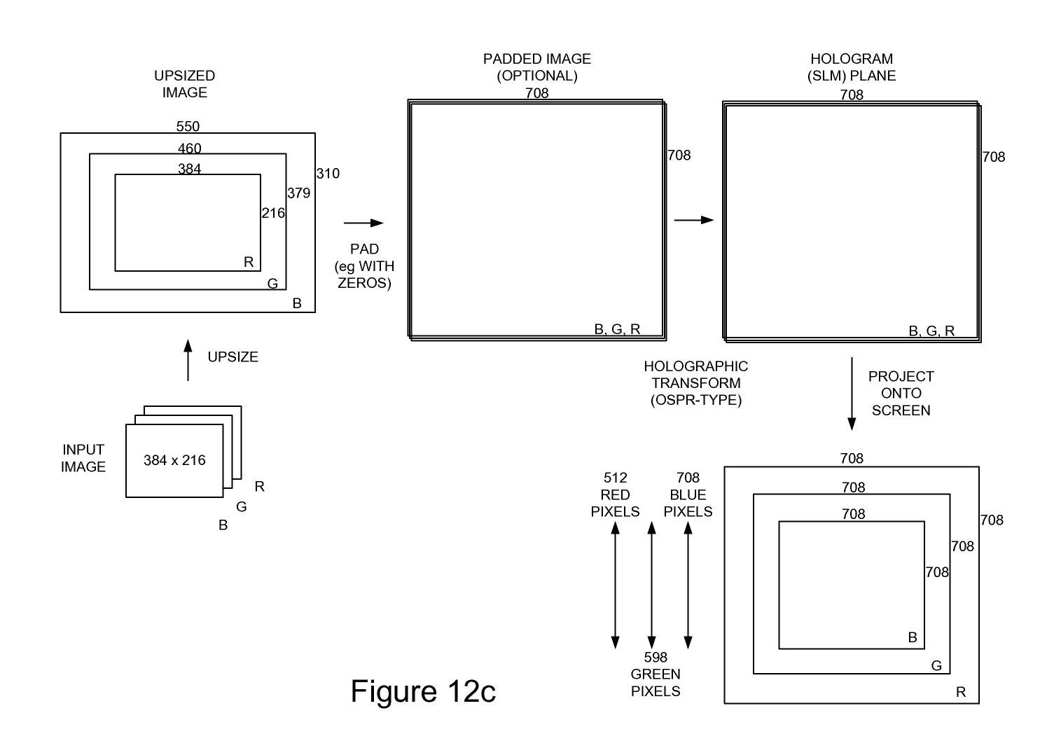

FIG. 12a shows an example colour holographic image projection system 1000, here including demagnification optics 1014 which project the holographically generated image onto a screen 1016. The system comprises red 1002, green 1006, and blue 1004 collimated laser diode light sources, for example at wavelengths of 638 nm, 532 nm and 445 nm, driven in a time-multiplexed manner. Each light source comprises a laser diode 1002 and, if necessary, a collimating lens and/or beam expander. Optionally the respective sizes of the beams are scaled to the respective sizes of the holograms, as described later. The red, green and blue light beams are combined in two dichroic beam splitters 1010a, b and the combined beam is provided (in this example) to a reflective spatial light modulator 1012; the Figure shows that the extent of the red field would be greater than that of the blue field. The total field size of the displayed image depends upon the pixel size of the SLM but not on the number of pixels in the hologram displayed on the SLM.

FIG. 12b shows padding an initial input image with zeros in order to generate three colour planes of different spatial extents for blue, green and red image planes. A holographic transform is then performed on these padded image planes to generate holograms for each sub-plane; the information in the hologram is distributed over the complete set of pixels. The hologram planes are illuminated, optionally by correspondingly sized beams, to project different sized respective fields on to the display screen. FIG. 12c shows upsizing the input image, the blue image plane in proportion to the ratio of red to blue wavelength (638/445), and the green image plane in proportion to the ratio of red to green wavelengths (638/532) (the red image plane is unchanged). Optionally the upsized image may then be padded with zeros to a number of pixels in the SLM (preferably leaving a little space around the edge to reduce edge effects). The red, green and blue fields have different sizes but are each composed of substantially the same number of pixels, but because the blue, and green images were upsized prior to generating the hologram a given number of pixels in the input image occupies the same spatial extent for red, green and blue colour planes. Here there is the possibility of selecting an image size for the holographic transform procedure which is convenient, for example a multiple of 8 or 16 pixels in each direction.

It is possible to correct for aberrations in the optical system by storing and applying a wavefront correction (multiplying by the wavefront conjugate in the procedure of FIG. 10d). Wavefront correction data may be obtained by employing a wavefront sensor or by using an optical modelling system; Zernike polynomials and Seidel functions provide a particularly economical way of representing aberrations.

Broadly speaking we have described a head-up display system which produces a virtual image at a distance of greater than 6 m, in embodiments greater than 20 m or 50 m, equipped with a high resolution image source (equal to or greater than VGA). A graphic generation system is included for rendering graphics in perspective projection, and a system layer collects information to enable the system to determine the topography of the external scene with which the contact analogue display is to be merged. This information includes information relating to car movement, attitude, position and characteristics, and to the external context, including information derived from sensors, and/or imagery and/or one or more databases.

In embodiments the attitude sensors comprise a horizon detection sensor, for example a forward-looking camera, and a verticality sensor. The topographic information characterising the external scene may be derived from one or more of a GPS sensor, a topographic database, and an external camera or cluster of cameras.

In embodiments the system layer also collects information enabling the detection of occlusion, for example by means of front radar or a forward-looking camera. Other features of embodiments of the system include means for identifying light and shadow including, for example, a forward-looking camera (or camera pair for shadow detection), the vehicle's light sensor, day/night mode data, (headlamp) beam data, as well as time/date/location data Embodiments of the system may also employ speed/acceleration data, for example deriving speed from an in-car bus such as a CAN-bus and/or an accelerometer and/or GPS.

Optionally the HUD system may incorporate an additional system to conform the display to the user/driver, more particularly to the attitude of the user. This may comprise a vertical head position detector such as a driver-viewing camera, head position tracker or eye tracking system, and/or a lateral head position detecting system such as a driver-viewing camera, head position tracker, or eye tracking system. However this is not necessary for some preferred embodiments of the invention.

### Light Shields for Head-Up Displays

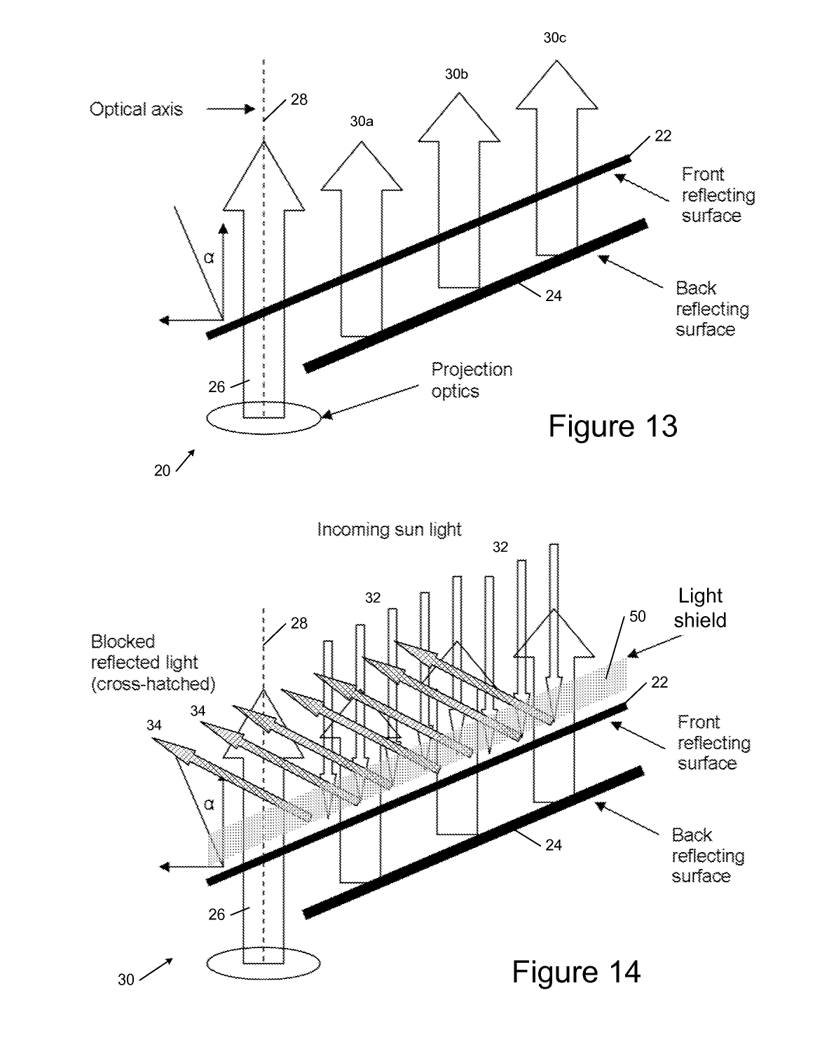

The output stage of the head-up display architecture shown in FIG. 3 can be represented as illustrated in FIG. 13, which shows a pupil expander 20 comprising substantially parallel front 22 and rear 24 reflecting surfaces into which a collimated input beam 26 bearing an image for display is injected at an angle α to the normal to the (planar) reflecting surfaces. The angle α defines a tilt angle of the pupil expander and the direction of the input beam 26 defines an optical axis 28 for the system. At successive reflections from the back reflecting surface the input beam is replicated 30a, b, c . . . , to provide an expanded exit pupil for the system.

In terms of its behaviour with respect to external solar illumination, this architecture has two important characteristics: the last surface (front reflecting surface 22) is reflective and the image formed by the HUD is formed by a light beam passing through this surface, and the image is projected off-axis to this last surface. This latter point means that there is a non-null angle α between the optical axis 28 of the projection optics and the front mirror 22 (typically, α=30°). Thus with this architecture the vast majority of the incoming visible external light is reflected by the front reflective surface 22. For this reason, if we apply an angular selection on the useful angles coming out of the HUD the projected image can be almost unaffected whereas the incoming rays can be trapped by the light shield. More particularly the reason that the incoming rays can be trapped is that the mirror surface 22 reflects these rays off surface 22 with a significantly changed angle.

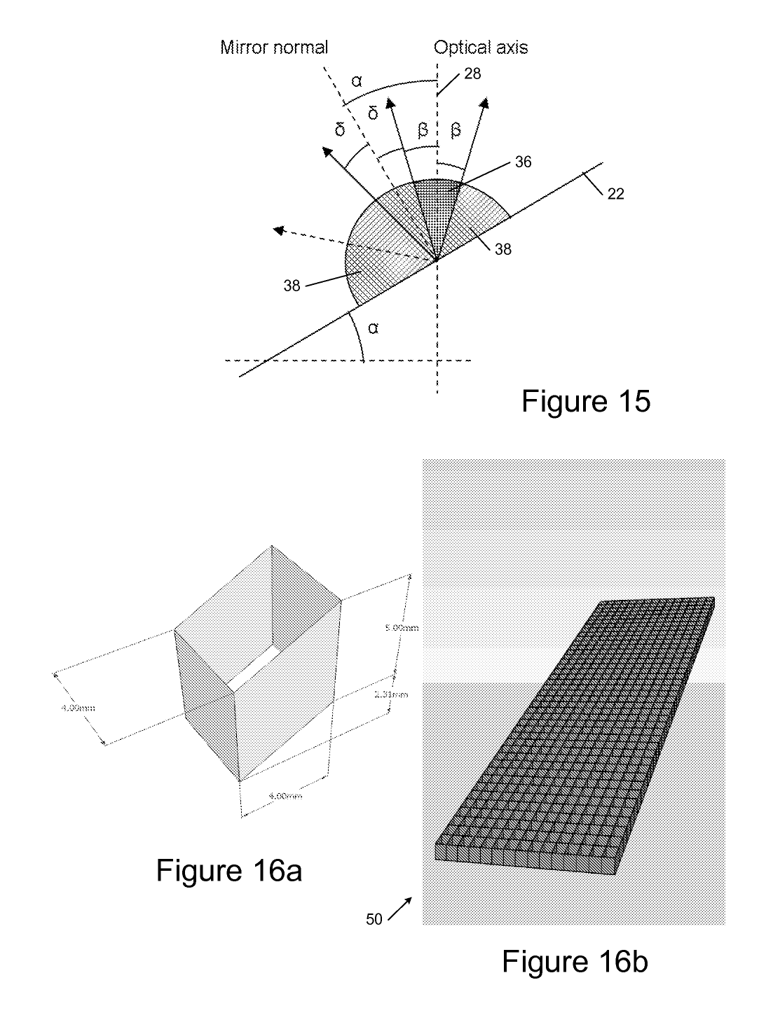

A practical embodiment of the pupil expander 20 of FIG. 13 incorporating a light shield or baffle 50 is illustrated in FIG. 14. In this figure incoming sunlight 32 is reflected from a front surface 22 as illustrated by cross-hatched arrows 34. The light shield or baffle 50 comprises a set of tubes (shown in cross-section in FIG. 14), the tubes being longitudinally aligned along the optical axis 28 and aligned at an angle to the perpendicular to the front reflecting surface 22. This light trap is effective especially where the reflectivity of the front reflecting surface 22 is high, and where the field of view of the HUD is reasonably small and in proportion to (of a similar order of magnitude size as) the tilt angle α of the pupil expander. This latter statement can be formalised into an approximate first order relation between the maximum field of view (FOV) and the angle α: if we assume that the light shield ideally passes the maximal viewing angles and that this same light shield ideally blocks all the reflected light entering through these angles, then we can formalise the condition that these two domains do not overlap: referring to FIG. 15, this shows the geometry of the system, the rectangular cross-hatching 36 showing the allowed output angles according to the field of view of the HUD, the diagonal cross-hatching 38 illustrating angles of blocked reflected light from surface 22. In FIG. 15 the field of view angular filtering selects the angles ranging from +β to −β around the optical axis (where 2β is the field of view). This filtering allows some incoming light to be reflected on the mirror surface. The incoming light beams with incident angles from +β to −β around the optical axis get reflected along the mirror's normal axis and appear emerging from the mirror within a certain range of angles.

A condition to realise to block this light is to ensure that none of the emerging angles are in the acceptance region of the angular filtering (i.e. from +β to −β around the optical axis).

This condition can be expressed as follows:

$$α + δ > β$$

$$α + ( α - β ) > β$$

$$α > β$$

$$α > \frac{MaxFOV}{2}$$

This condition links the tilt of the optical axis with regard to the mirror's normal with the maximum field of view (FOV) of the HUD. This is a necessary but not sufficient condition to formalise that the two aforementioned domains do not overlap although, as previously mentioned, in a practical system it may not always be desirable to impose this condition.

FIG. 14 schematically illustrates an angular filter comprising an array of tubes. However there are many other ways in which the angular filtering could be implemented including,
1. Dielectric angular filtering layers,
2. Microstructures (based on metallic layers or on diffractive optical element,
3. Index variations (total internal reflection trap), potentially limited by the index differences,
4. Holograms,
5. Other shutter structures.

The applicability of these different techniques depends upon the type of head-up display and, for example, on whether or not coherent light, or polarised light, or multi colour light is employed. For example a hologram or other diffractive optical element is a potentially useful option as this may be configured to pass a range of angles for one or more of a set of colours. Alternatively if polarised light is employed a reflective polariser, for example of the type available from Moxtek Inc, USA may be employed as an angular filter since such materials (for example their ProFlux™ line) can have an angle-dependent response. In another approach a TIR-based angular trap may be provided as a thin layer in front of the front reflecting surface 22. In a still further approach microprisms may be employed, although these are less preferable because they can introduce artefacts. In yet another approach a pair of microlens arrays may be positioned to either side of a mask, again these elements lying across the front of the front reflecting surface 22 (see, for example, U.S. Pat. No. 5,351,151 which describes an optical filter device arranged along these lines). The skilled person will appreciate that an appropriate angular filter may be selected based upon, for example, the type of head-up display employed and upon cost. However, a particularly advantageous, and inexpensive, structure comprises an array of hollow prisms.

In more detail a preferred shutter or baffle structure comprises an array of hollow, oblique, tube-like prisms, preferably fabricated from or coated with a light-absorbing material. These tubes or prisms are oriented with an axis along the optical axis 28 and can be used in one or more layers having a defined height. FIGS. 16a and 16b show an example of such a structure which uses square base oblique prisms, with a tilted lower open end angled to match the tilt angle of the pupil expander (in the illustrated example, 30°).

Such an elementary structure can be made easily out of plastic or any light absorbing material structured in thin layers. It is preferable that the sides of the prisms are as thin as possible (within mechanical requirements) to avoid unnecessarily blocking light. There is no specific requirement for the base of the prisms to be a square. A hexagonal base (honeycomb type structure) can be a good solution for regularity and symmetry for ease of fabrication of the structure, as well as for perception (breaking the usual square angle geometry).

One important design choice of the shutter structure is the height of the prisms. This height is preferably selected based on:
Tilt angle of the optical axis with reference to the mirror's normal axis,
Viewing angles of the HUD,
Prisms' base dimension.

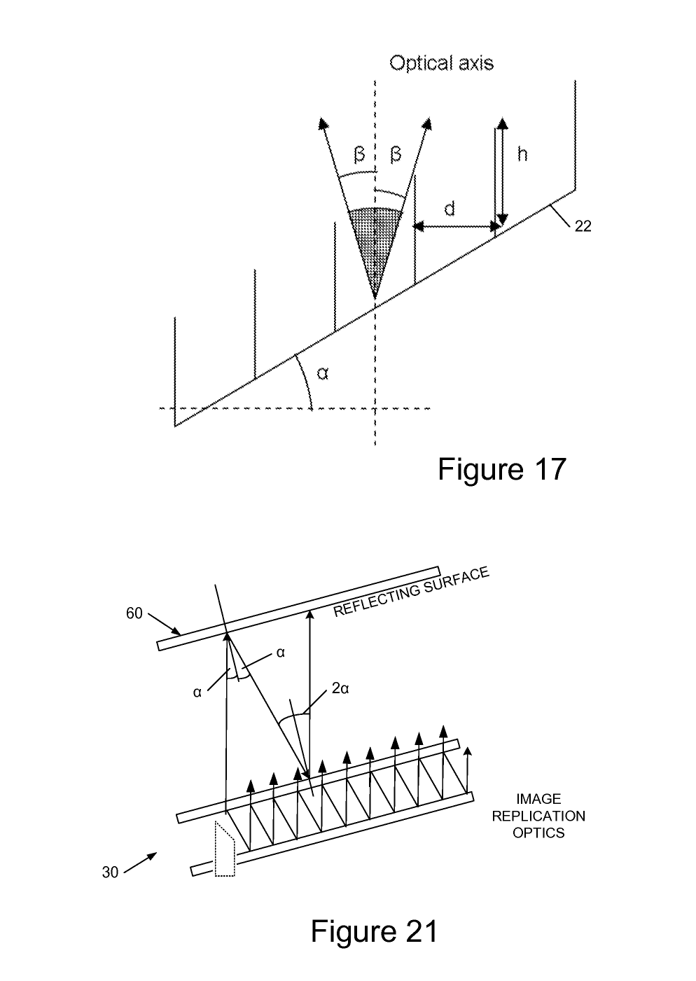

A dimensioning procedure for a simple square base case is described hereafter. Referring to FIG. 17, assume the following notation:
α the tilt angle of the optical axis with reference to the mirror's normal axis,

$$β > \frac{MaxFOV}{2}$$

the half angle of the maximal field of view,
d the dimension of the elementary cell of the shutter,
h the height (along the optical axis) of the shutter.

A preferable condition to fulfill is that the complete field of view is visible from the centre of each cell. This formalises as follows:

$$\frac{d}{2} \cdot ( \frac{1}{tan β} - tan α ) \geq h$$

It is also preferable that at least the incoming rays parallel to the optical axis are fully blocked.

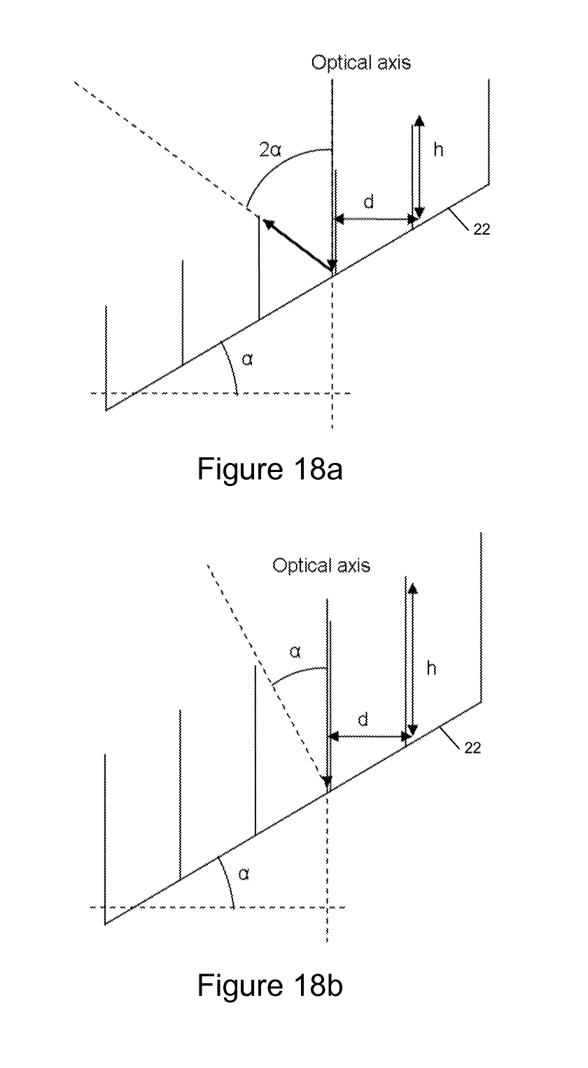

Referring to FIG. 18a, this condition can be expressed as follows:

$$h > d \cdot ( \frac{1}{tan 2 α} + tan α )$$

Practically, if we consider the following example case:
α=30°
β=5
d=5 mm

Then we have:

5.8 mm<h<27 mm

It can be appreciated that this leaves significant design freedom. The final selection of the height of the cell can be made based on the practical sun positions (in the intended application, for example position on a car dashboard) and bearing in mind that the height is preferably kept minimal to optimise light transmission in the complete angular range.

In addition to this, it is possible to calculate the condition that no incoming light (whether or not parallel to the optical axis) can escape the optical system after reflecting on the reflecting surface 22.

Referring to FIG. 18b this can be expressed as follows:

$$h > \frac{d}{cos α \cdot sin α}$$

which in the numerical example case above gives:

11.6 mm<h<27 mm.

### Light Shield Theoretical Analysis

We now consider a theoretical analysis of potential requirements for a generalised angular filter. This analysis assumes that the angular filtering performed on top of the reflecting surface is a perfectly sharp filtering forming a Heavyside step function.

We first explain the conditions under which no incoming light can emerge from the optical system after a reflection on the reflecting surface (condition for total light extinction).

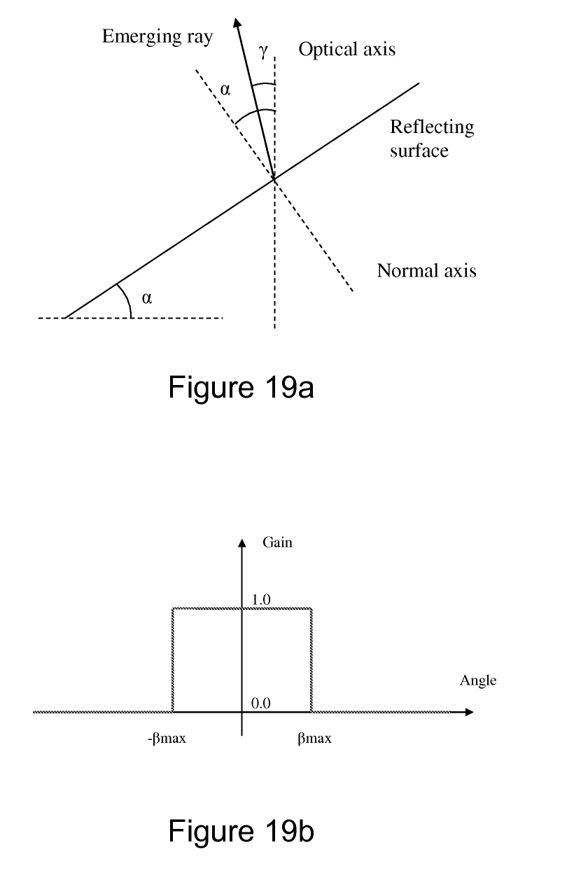

Referring to the configuration of FIG. 19a, if we consider an emerging ray forming an angle γ with the optical axis (counter clockwise-positive notation), the angular filtering can be characterised as shown in FIG. 19b.

FIG. 19b shows that only the emerging rays with an angle in the range [−βmax: +βmax] around the optical axis would be allowed out. This filtering is assumed to be equally true for the incoming rays meaning that only the incoming rays forming an angle in the range [−βmax: +βmax] around the optical axis would be allowed in.

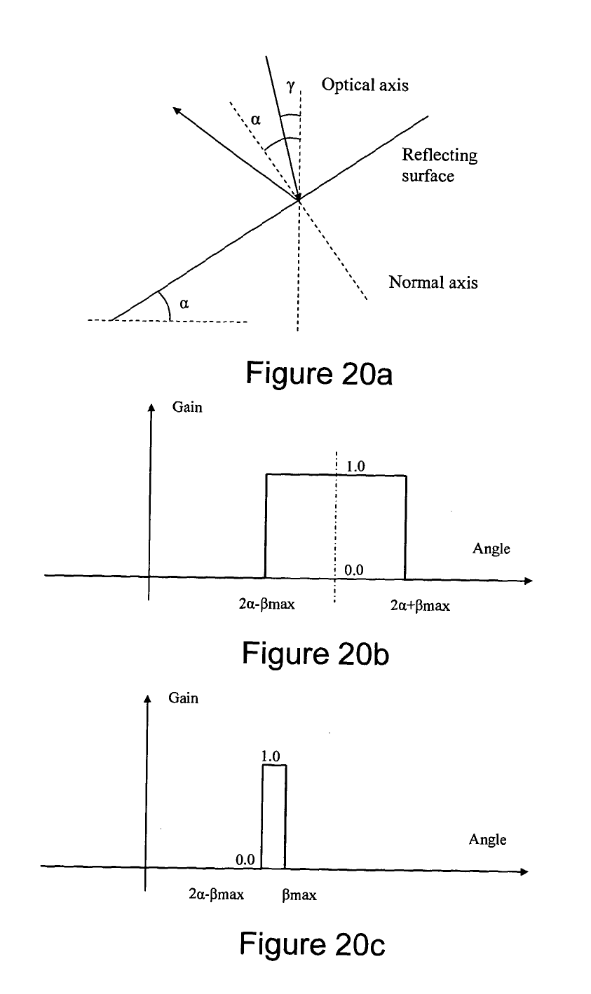

Now consider an incoming ray reflected on the front reflecting surface, as shown in FIG. 20a: This ray would emerge from the system with an angle α+(α−γ)=2α−γ. Knowing the filtering on incoming rays, we can identify the possible range of emerging rays, as shown in FIG. 20b.

Now these emerging rays need to pass again through the angular filtering which means that the filtering function on an incoming ray would be as shown in FIG. 20c. Hence, an incoming ray cannot escape from the system when:

2·α−βₘₐₓ>βₘₐₓ

α>βₘₐₓ

This is the condition for total extinction of incoming light, assuming the angular filtering is perfect.

Referring now to FIG. 21, this shows a special use case of a head-up display 30 incorporating a light shield as previously described, where the HUD projects an image towards a mirror in a particularly penalizing orientation. In the example of FIG. 21, the pupil expander directs light towards a reflecting surface which is angled so as to direct image-carrying light from the head-up display back into the head-up display—the incoming light is a reflection of the outgoing light. The reflecting surface could be, for example, a mirror placed inside the car or a portion of a windshield (if the windshield is curved there is a greater risk of a portion of the windshield having the orientation shown in FIG. 21, reflecting light back into the head-up display). Light reflected back in can be reflected by the surface of the pupil expander and cause an echo image (viewable in a different direction to the main image). As can be seen from the geometry shown in FIG. 21, incoming light is at an angle 2α to the optical axis and thus a light shield of the type previously described can effectively inhibit such light from re-entering the head-up display.

Broadly speaking we have described a light shield for systems producing virtual images through a significantly reflective surface non-normal to the projection axis. The virtual nature of the image allows the light shield to be placed in a plane distinct from the image plane so that it is not visible (and generates few artefacts). The reflective nature of the optical surface contributes to the filtering of the incoming light by reflection (in part, the origin of the problem). The off-optical axis nature of the system enables the system to work as we have described because this allows the reflecting surface to deflect the incoming light towards the shield. Thus the light shield may comprise a straight forward angular filter applied on top of the reflecting surface such that it acts not only as an angular filter, but also as a light trap.

No doubt many other effective alternatives will occur to the skilled person. It will be understood that the invention is not limited to the described embodiments and encompasses modifications apparent to those skilled in the art lying within the spirit and scope of the claims appended hereto.

1. A road vehicle contact-analogue head up display (HUD), the head up display comprising:
a laser-based virtual image generation system, the virtual image generation system comprising at least one laser light source coupled to image generating optics to provide a light beam bearing one or more substantially two-dimensional virtual images;
exit pupil expander optics optically coupled to said laser-based virtual image generation system to receive said light beam bearing said one or more substantially two-dimensional virtual images and to enlarge an eye box of said HUD for viewing said virtual images;
a sensor system input to receive sensed road position data defining a road position relative to said road vehicle, said road position data including data defining a lateral position of a road on which the vehicle is travelling relative to said road vehicle, and a vehicle pitch or horizon position;
a symbol image generation system to generate symbology image data for contact-analogue display by said HUD; and
an imagery processor coupled to said symbol image generation system, to said sensor system input and to said virtual image generation system, to receive said symbology image data for contact-analogue display and to process said symbology image data to convert said symbology image data to data defining a substantially two dimensional image dependent on said sensed road position data for input to said virtual image generation system for display by said HUD such that when said one or more substantially two dimensional images are viewed with said HUD the viewed virtual image appears to a viewer at a substantially fixed position relative to said road; and
wherein said virtual image is at a distance of at least 5 m from said viewer.

2. A road vehicle contact-analogue HUD as claimed in claim 1 wherein said virtual image is at a distance of at least 10 m from said viewer, preferably 20 m from said viewer, or substantially at infinity.

3. A road vehicle contact-analogue HUD as claimed in claim 1, wherein said exit pupil expander optics are configured to provide a said virtual image having a field of view of at least 10 degrees.

4. A road vehicle contact-analogue HUD as claimed in claim 1, wherein said laser-based virtual image generation system has a resolution, in a replay field of said virtual image, of at least 640×480 pixels.

5. A road vehicle contact-analogue HUD as claimed in claim 1, wherein said imagery processor is configured to apply one or more monocular cues to said symbol image data such that when said substantially two dimensional image is viewed at least part of said substantially two dimensional image appears to be at a different distance to the distance of said virtual image from said viewer, in particular closer to said viewer than said distance of said virtual image from said viewer.

6. A road vehicle contact-analogue HUD as claimed in claim 1, further comprising a system to track a position of said viewer's head, and wherein said imagery processor is configured to apply artificial parallax to said virtual image dependent on said head position, to move one portion of displayed symbology with respect to another portion of displayed symbology to give the impression of parallax.

7. A road vehicle contact-analogue HUD as claimed in claim 5, wherein said symbology image data includes data for a graphical representation of a real-life object, and wherein said applying of a monocular cue comprises scaling a size of said graphical representation responsive to a combination of object size data defining a size of said real-life object and a desired apparent depth at which said object is to appear to said viewer, such that when said graphical representation is viewed by said viewer said scaled size matches, for an object at said desired apparent depth, said size defined by said object size data, whereby to said viewer said object has an apparent depth determined by a familiar size of said real-life object at said desired apparent depth.

8. A road vehicle contact-analogue HUD as claimed in claim 5, wherein said sensor system input is configured to receive environmental condition data comprising data identifying one or more of a day/night condition, a degree of natural illumination, and a distance of visibility for a driver, and wherein said applying of a monocular cue comprises field-dependent modification of said symbol image data responsive to said environmental condition data.

9. A road vehicle contact-analogue HUD as claimed in claim 5, wherein said sensed road position data includes data identifying a horizontal orientation of said road vehicle, and wherein said applying of a monocular cue comprises modifying said symbol image data responsive to said horizontal orientation and to a time of day to add a simulated sun shadow to at least a graphical element of said symbology image data.

10. A road vehicle contact-analogue HUD as claimed in claim 1, wherein said symbology image data comprises three dimensional model data defining a three dimensional model comprising said symbology.

11. A road vehicle contact-analogue HUD as claimed in claim 1, wherein said sensed road position data comprises a captured image of said road, and wherein said HUD further comprises a sensor image processor to identify at least said lateral position of said road and one or both of said vehicle pitch and horizon position from said captured image of said road.

12. A road vehicle contact-analogue HUD as claimed in claim 1, comprising a sensor input to receive an occlusion detection signal and an occlusion detection processor coupled to said sensor input to detect occlusion of part of said road in front of said vehicle, and wherein said imagery processor is responsive to said occlusion detection to modify said symbology image data for said viewer.

13. A road vehicle contact-analogue HUD as claimed in claim 12 wherein said modification of said symbology image data comprises ceasing to map said symbology to said road.

14. A road vehicle contact-analogue HUD as claimed in claim 12 wherein said modification of said symbology image data comprises occluding a portion of said symbology image data responsive to said detected occlusion such that when said one or more substantially two dimensional images are viewed with said HUD the viewed virtual image appears occluded by said detected occlusion.

15. A road vehicle contact-analogue HUD as claimed in claim 1, wherein said exit pupil expander optics comprise a set of substantially parallel planar optical surfaces having an output optical surface comprising a partially transmissive optical surface and a reflecting rear optical surface, wherein said planar parallel optical surfaces define substantially parallel planes spaced apart in a direction perpendicular to said parallel planes, and wherein said substantially planar optical surfaces define optical surfaces of a waveguide configured such that said light beam bearing said one or more substantially two dimensional images is launched into said waveguide, is reflected along said waveguide, and escapes through said output optical surface at reflections from said output optical surface.

16. A road vehicle contact-analogue HUD as claimed in claim 1, wherein said image generating optics comprise a spatial light modulator (SLM) to display a hologram of said one or more substantially two-dimensional images and illumination optics in an optical path between said laser light source and said SLM to illuminate said SLM, and wherein said virtual image generation system further comprises a hologram generation processor having an input to receive image data for display and an output for driving said SLM, wherein said hologram generation processor is configured to process said image data and output hologram data for display on said SLM in accordance with said image data to generate said light beam bearing said one or more substantially two-dimensional virtual images.

17. A road vehicle contact-analogue HUD as claimed in claim 16 wherein said hologram generation processor is configured to generate a plurality of temporal holographic subframes for encoding each said substantially two-dimensional image, for display in rapid succession on said SLM such that corresponding images within a viewer's eye average to give the impression of a reduced noise image.

18. A road vehicle contact-analogue head up display (HUD), the head up display comprising:
a virtual image generation system to generate a virtual image for viewing at a virtual image distance of at least 5 metres;
a sensor system input to receive sensed road position data defining a road position relative to said road vehicle, said road position data including data defining a lateral position of a road on which the vehicle is travelling relative to said road vehicle, and a vehicle pitch or horizon position;
a symbol image generation system to generate symbology image data for contact-analogue display by said HUD; and
an imagery processor coupled to said symbol image generation system, to said sensor system input and to said virtual image generation system, to receive said symbology image data for contact-analogue display and to process said symbology image data to convert said symbology image data to data defining an image dependent on said sensed road position data for input to said virtual image generation system, such that when said virtual image is viewed with said HUD the viewed virtual image appears to a viewer at a substantially fixed position relative to said road; and
further comprising an occlusion sensor input to receive an occlusion detection signal and an occlusion detection processor coupled to said occlusion input to detect occlusion of part of said road in a field of view addressed by the head-up display, and wherein said imagery processor is responsive to said occlusion detection to modify said symbology image data for said viewer.

19. A road vehicle contact-analogue HUD as claimed in-claim 18 wherein said occlusion sensor comprises a one- or two-dimensional radar sensor, and wherein said occlusion detection signal comprises a radar target detection signal.

20. A road vehicle contact-analogue HUD as claimed in claim 18 wherein said occlusion detection signal comprises an image, wherein said occlusion sensor input comprises an image sensor input to receive an image of said road, and wherein said occlusion detection processor is configured to process said image to detect said occlusion of part of said road in front of said vehicle.

21. A road vehicle contact-analogue HUD as claimed in claim 18, configured to detect a said occlusion of part of said road at no greater distance than 100 m in front of said vehicle.

22. A road vehicle contact-analogue HUD as claimed in claim 18 wherein said modification of said symbology image data comprises ceasing to map said symbology to said road.

23. A road vehicle contact-analogue HUD as claimed in claim 18 wherein said modification of said symbology image data comprises occluding a portion of said symbology image data responsive to said detected occlusion such that when said virtual image is viewed with said HUD the viewed virtual image appears occluded by said detected occlusion.

24. A road vehicle contact-analogue HUD as claimed in claim 18 wherein said symbology image data comprises three dimensional image data, wherein said occlusion detection processor is configured to generate occlusion data defining a three dimensional representation of a said occlusion, and wherein said imagery processor is configured to generate three dimensional data representing an occluded version of said three dimensional symbology imagery data to generate a modified version of said symbology data for said virtual image generation system.

25. A road vehicle contact-analogue HUD as claimed in claim 18 wherein said imagery processor is configured to apply one or more monocular cues to said symbol image data such that when said virtual image is viewed at least part of said virtual image appears to be at a different distance to the distance of said virtual image from said viewer.

26. A road vehicle contact-analogue HUD as claimed in claim 25 wherein said symbology image data includes data for a graphical representation of a real-life object, and wherein said applying of a monocular cue comprises scaling a size of said graphical representation responsive to a combination of object size data defining a size of said real-life object and a desired apparent depth at which said object is to appear to said viewer, such that when said graphical representation is viewed by said viewer said scaled size matches, for an object at said desired apparent depth, said size defined by said object size data, whereby to said viewer said object has an apparent depth determined by a familiar size of said real-life object at said desired apparent depth.

27. A road vehicle contact-analogue HUD as claimed in claim 25 wherein said sensor system input is configured to receive environmental condition data comprising data identifying one or more of a day/night condition, a degree of natural illumination, and a distance of visibility for a driver, and wherein said applying of a monocular cue comprises field-dependent modification of said symbol image data responsive to said environmental condition data.

28. A road vehicle contact-analogue HUD as claimed in claim 25, wherein said sensed road position data includes data identifying a horizontal orientation of said road vehicle, and wherein said applying of a monocular cue comprises modifying said symbol image data responsive to said horizontal orientation and to a time of day to add a simulated sun shadow to at least a graphical element of said symbology image data.

29. A road vehicle contact-analogue HUD as claimed in claim 18 wherein said virtual image generation system is a laser-based virtual image generation system including at least one laser light source coupled to image generating optics to generate said light beam bearing said virtual image.

30. A road vehicle contact-analogue HUD as claimed in claim 29 wherein said image generating optics comprise a spatial light modulator (SLM) to display a hologram of one or more substantially two-dimensional images and illumination optics in an optical path between said laser light source and said SLM to illuminate said SLM, and wherein said virtual image generation system further comprises a hologram generation processor having an input to receive image data for display and an output for driving said SLM, wherein said hologram generation processor is configured to process said image data and output hologram data for display on said SLM in accordance with said image data.

31. A road vehicle contact-analogue HUD as claimed in claim 18 further comprising exit pupil expander optics optically coupled to said virtual image generation system to receive said light beam bearing said virtual image and to enlarge an eye box of said HUD for said viewing of said virtual image.

32. A road vehicle contact-analogue HUD as claimed in claim 31 wherein said exit pupil expander optics comprise a set of substantially parallel planar optical surfaces having an output optical surface comprising a partially transmissive optical surface and a reflecting rear optical surface, wherein said planar parallel optical surfaces define substantially parallel planes spaced apart in a direction perpendicular to said parallel planes, and wherein said substantially planar optical surfaces define optical surfaces of a waveguide configured such that said light beam bearing said one or more substantially two dimensional images is launched into said waveguide, is reflected along said waveguide, and escapes through said output optical surface at reflections from said output optical surface.

33. A road vehicle contact-analogue HUD as claimed in claim 18 wherein said virtual image is at a distance of at least 10 m or 20 m from said viewer, or substantially at infinity.

34. A head up display, the display comprising a virtual image generation system to generate a virtual image for presentation to an optical combiner to combine light exiting said image generation system bearing said virtual image with light from an external scene, for presentation of a combined image to a user, wherein said virtual image generation system has output optics including a partially reflecting optical surface, wherein an optical axis of said light exiting said image generation system is tilted with respect to a normal to said optical surface, defining a tilt angle of greater than zero degrees between said optical axis and said normal to said optical surface, and wherein said partially reflecting optical surface has an angular filter on an output side of said optical surface to attenuate external light reflected from said partially reflecting optical surface at greater than a threshold angle to said optical axis.

35. A head up display as claimed in claim 34 wherein said threshold angle is substantially equal to said tilt angle.

36. A head up display as claimed in claim 34 wherein said threshold angle is substantially equal to half a maximum field of view of said head up display.

37. A head up display as claimed in claim 34 wherein said tilt angle is greater than half a maximum field of view of said head up display.

38. A head up display as claimed in claim 34 wherein said angular filter comprises an array of tubes each extending longitudinally along said optical axis.

39. A head up display, the display comprising a virtual image generation system to generate a virtual image for presentation to an optical combiner to combine light exiting said image generation system bearing said virtual image with light from an external scene, for presentation of a combined image to a user, wherein said virtual image generation system has output optics including a partially reflecting optical surface, wherein an optical axis of said light exiting said image generation system is tilted with respect to a normal to said optical surface, defining a tilt angle of greater than zero degrees between said optical axis and said normal to said optical surface, and wherein said partially reflecting optical surface has a baffle adjacent said optical surface, said baffle comprising an array of tubes each extending longitudinally along said optical axis of said light exiting said image generation system.

40. A head up display as claim in claim 38 wherein light entering said head up display along said optical axis at an edge of a said tube is reflected off said partially reflecting surface at substantially said tilt angle, and wherein a said tube has a longitudinal length which is sufficiently long for said light reflected at said tilt angle at said edge of said tube to be substantially blocked by a side wall of said tube.

41. A head up display as claimed in claim 40 wherein a longitudinal length of a said tube, h, satisfies:
$$h > {d}_{max} \cdot ( \frac{1}{tan 2 α} + tan α )$$
where dₘₐₓ is a maximum internal lateral dimension of said tube and α is said tilt angle.

42. A head up display as claimed in claim 38 wherein light entering said head up display at an angle to said optical axis equal to or greater than said tilt angle and incident on said optical surface at a centre of a said tube is reflected from said output optical surface and substantially blocked by a side wall of said tube.

43. A head up display as claimed in claim 38 wherein light entering said head up display at an angle to said optical axis equal to or greater than half a maximum field of view of said head up display and incident on said optical surface at a centre of a said tube is reflected from said output optical surface and substantially blocked by a side wall of said tube.

44. A head up display as claimed in claim 38 wherein a longitudinal length of a said tube, h, satisfies:
$$h > \frac{{d}_{max}}{cos α \cdot sin α}$$
where dₘₐₓ is a maximum internal lateral dimension of said tube and α is said tilt angle.

45. A head up display as claimed in claim 38 wherein a said tube has a minimum lateral internal dimension which is sufficiently large for a field of view of said head up display to be substantially unrestricted by said baffle.

46. A head up display as claimed in claim 38 wherein a minimum internal lateral dimension of said tube, dₘᵢₙ where length of said tube, h satisfies:
$$h \leq \frac{{d}_{min}}{2} \cdot ( \frac{1}{tan ( FOV / 2 )} - tan α )$$
α is said tilt angle and FOV is a maximum field of view of said display in the absence of said baffle.

47. A head up display as claimed in claim 38 wherein said array of tubes comprises a close packed array of substantially hexagonal cross-section tubes.

48. A head up display as claimed in claim 34 wherein said partially reflecting surface has a reflectance of at least 80% at a wavelength in the range 400 nm to 700 nm.

49. A head up display as claimed in claim 34 wherein said partially reflecting surface is a final output optical surface of said output optics.

50. A head up display as claimed in claim 34 wherein said output optics comprise exit pupil expander optics.

51. A head up display as claimed in claim 34 wherein said output optics comprise at least one set of substantially planar parallel optical surfaces having an output optical surface comprising said partially reflecting optical surface and a rear reflecting optical surface, wherein said planar parallel optical surfaces define substantially parallel planes spaced apart in a direction perpendicular to said parallel planes, and wherein said substantially planar optical surfaces define optical surfaces of a waveguide such that light launched into said waveguide parallel to said optical axis is reflected along said waveguide and escapes through said output optical surface when reflected at said output optical surface.

52. A head up display as claimed in claim 51 wherein said virtual image generation system includes an image production system to generate a beam of substantially collimated light carrying said virtual image, and wherein said virtual image generation system is optically coupled to said output optics and configured to launch said collimated light into said waveguide along a direction substantially parallel to said optical axis.

53. A head up display as claimed in claim 51 wherein said virtual image generation system is a laser-based image generation system.

54. A method of inhibiting reflections of incoming light in a head up display as claimed in claim 34, the method comprising:
generating a substantially collimated light beam comprising a virtual image for display, said virtual image having a field of view, said light beam defining an optical axis;
passing said light beam through a tilted partially reflective optical surface, a normal to said optical surface having a greater than zero angle to said optical axis;
passing said light beam exiting said tilted optical surface through an optical angular filter to attenuate light at greater than a threshold angle to said optical axis;
wherein light in said collimated beam within said field of view is substantially unattenuated by said angular filter, and wherein at least some incoming light incident on said tilted partially reflective optical surface through said optical angular filter is partially reflected back towards said angular filter at greater than said threshold angle and attenuated.

55. A head up display as claimed in claim 34 including means for inhibiting reflections of incoming light, the head up display comprising:
means for generating a substantially collimated light beam comprising a virtual image for display, said virtual image having a field of view, said light beam defining an optical axis;
wherein an optical path for said light beam in said device passes through a tilted partially reflective optical surface, a normal to said optical surface having a greater than zero angle to said optical axis;
wherein, in an output direction, said optical path exits said tilted optical surface through an optical angular filter to attenuate light at greater than a threshold angle to said optical axis; and
wherein light in said collimated beam within said field of view is substantially unattenuated by said angular filter, and wherein at least some incoming light incident on said tilted partially reflective optical surface through said optical angular filter is partially reflected back towards said angular filter at greater than said threshold angle and attenuated.
